(19) United States
(12) Patent Application Publication
(10) Pub. No.: US 2012/0036888 A1
(43) Pub. Date: Feb. 16, 2012

(54) METHOD AND SYSTEM FOR THE SMALL-SCALE PRODUCTION OF LIQUIFIED NATURAL GAS (LNG) AND COLD COMPRESSED GAS (CCNG) FROM LOW-PRESSURE NATURAL GAS

(76) Inventor: David Vandor, Tarrytown, NY (US)

(21) Appl. No.: 13/216,803

(22) Filed: Aug. 24, 2011

Related U.S. Application Data
(63) Continuation-in-part of application No. 11/934,845, filed on Nov. 5, 2007, now Pat. No. 8,020,406.

(51) Int. Cl. F25J 1/00; F17C 13/00; F17C 7/00

(52) U.S. Cl. 62/613; 222/1; 220/560.04

(57) ABSTRACT

A system for the production of LNG from low-pressure feed gas sources, at small production scales and at lower energy input costs. A system for the small-scale production of cold compressed natural gas (CCNG). A method of dispensing natural gas from stored CCNG, comprising: dispensing CCNG from a CCNG storage tank; pumping the CCNG by a cryogenic liquid pump to a pressure suitable for compressed natural gas dispensing and storage in on-vehicle compressed natural gas storage tanks; recovering cold from the CCNG by heat exchange with natural gas feeding the natural gas production plant to replace dispensed product. A system for the storage, transport, and dispensing of natural gas, comprising: means for handling natural gas in a CCNG state where the natural gas is a non-liquid, but is dense-enough to allow for pumping to pressure by a cryogenic liquid pump.

### CROSS-REFERENCES

This patent application is a continuation-in-part of patent application Ser. No. 11/934,845 by David Vandor, entitled “Method and System for the Small-scale Production of Liquefied Natural Gas (LNG) from Low-pressure Gas”, filed on Nov. 5, 2007, the entire contents of which are fully incorporated by reference herein.

### TECHNICAL FIELD

The present invention relates generally to the compression, refrigeration and liquefaction of gases, and more particularly to the liquefaction of a gas, such as natural gas, on a small scale.

### BACKGROUND

There are no commercially viable Small-Scale liquefied natural gas (“LNG”) production facilities anywhere in the world. “Small-Scale” means less than about 10,000 liters/day. Thus, any existing liquefied natural gas-fueled fleet must depend on deliveries by tanker truck from larger-scale LNG plants or from LNG import terminals. The use of tanker trucks or terminals increases the cost of the LNG to the end user, because the delivered price must include the substantial cost of transporting the LNG from the production or import location to the customer. Those transportation costs tend to outweigh the lower production costs of large-scale LNG manufacture, where there is a large distance between the LNG source and the customer. Also, the transport of LNG from production or import source to end-users requires that the LNG be as cold as possible so as to avoid “boil off” (and losses through pressure relief valves) during the transport process. Thus, the LNG needs to be produced at its coldest practical temperature, say, about 260° F., rather than at warmer temperatures, requiring more energy input. When LNG is dispensed as compressed natural gas (“CNG”) to vehicles, at facilities with no on-site liquefaction systems, the cold content of the LNG is dissipated in its conversion (by pumping to pressure and warming) to CNG, throwing away a significant amount of energy that was used to liquefy the LNG at its source. More generally, the standard model for CNG production and dispensing (in the absence of an on-site LNG source) requires large compressors that produce the CNG on demand, because CNG is not dense enough to allow for any practical way to store it in advance of its dispensing to vehicles. Thus, all CNG stations operate on a “just in time” production basis, without the ability to produce and store CNG during off-peak periods. The cost of “just in time” production is higher because it often includes peak period “demand charges” for the electricity used to run the oversized compressors. The present invention seeks to solve these and other problems associated with the standard forms of LNG production and transport, L/CNG dispensing, and CNG production and dispensing.

The LNG customer must also maintain a large storage tank so that deliveries can be spread out in time. Such tanks produce “boil off” which is generally vented to the atmosphere, causing methane emissions and loss of product, further increasing the net cost of the LNG, to both the end user and (by way of the emissions) to society at large. Heat gain to the storage tank, in the absence of on-site liquefaction, results in LNG that is not the ideal density for the vehicle's fuel tank. Re-liquefaction to avoid boil-off or to increase the product's density is not an option without an on-site LNG plant.

Other drawbacks to tanker-delivered LNG include the lack of competition in the industry, making the fleet owner excessively dependent on a single supplier. The quality of the delivered product may also vary, to the detriment of the fleet that uses the fuel.

The alternative that is commonly used is on-site Compressed Natural Gas (CNG) production, using the local natural gas pipeline as the feed source. However, such CNG systems have severe limitations, including the following: CNG, because it is not very dense, cannot be stored in large quantities, so it must be made at a high capacity during the peak vehicle fueling demand period. Similarly, the on-vehicle storage of CNG is limited by the need for heavy, high-pressure CNG tanks that store relatively little product, compared to the much denser LNG, and thus limit the travel range of the CNG vehicle. Also, because of the lack of CNG storage options, the typical CNG compressor must be “over-designed” so as to be able to meet the “just in time” demand of the local CNG fleet. In other words, if the CNG station is to fill any significant number of vehicles, fast enough to compete with standard fueling rates (such as for diesel fueling), then the compressor must have a very large throughput capacity, even if that capacity is idle during much of the day. The CNG produced is generally warm, due to the heat of compression, and must be sent through ambient air coolers to dissipate the heat gained during compression. However, that approach still leaves the CNG at some 15-degrees hotter than ambient, reaching about 100° F. and more. The hotter the CNG, the less dense it is, limiting the amount of product that can be dispensed into each vehicle's on-board storage tank. Moreover, by operating during the peak fueling demand period, the CNG station is likely running its large compressors during the peak electricity demand period, causing it to pay “demand charges” to the electric distribution company. The just in time model (without on site storage) does not allow for off-peak CNG production.

The only reason vehicle-grade LNG needs to be produced at the coldest possible temperatures is to allow it to “weather” the time it spends in transport vehicles and storage tanks, before it is dispensed to the vehicles.

Therefore, a system for the small-scale production of LNG from low-pressure pipelines and stranded wells is needed to overcome the above listed and other disadvantages of existing methods of converting low-pressure natural gas to a dense form that is easily storable and transportable Also, a method of dense-phase natural gas production, storage and dispensing is needed that allows for off-peak production and off-peak power use, and which results in lower energy input costs because reduced refrigeration input is required.

### SUMMARY

The disclosed invention relates to a system for the small-scale production of liquid natural gas comprising: a natural gas supply, the natural gas supply being at a pressure in a range of about 55 psia to about 350 psia; a prime mover in fluid communication with the natural gas supply, and in fluid communication with a third heat exchanger; a multi-stage compressor in operational communication with the prime mover; the multi-stage compressor comprising at least a first stage compressor, a second stage compressor, and a third stage compressor, and where the inlet temperature of fluid entering the first stage compressor is less than about 40° F., and where the inlet temperature of fluid entering the second stage compressor is less than about 40° F.; a first inter-cooler in fluid communication with the first stage compressor; a molecular sieve in fluid communication with the first inter-cooler and in fluid communication with the natural gas supply; a fourth heat exchanger in fluid communication with the molecular sieve and in fluid communication with the first stage compressor; a second inter-cooler in fluid communication with the second stage compressor; a first heat exchanger in fluid communication with the second inter-cooler and in fluid communication with the third stage compressor; an after-cooler in fluid communication with the third stage compressor; a second heat exchanger in fluid communication with the after-cooler; a main heat exchanger in fluid communication with the second heat exchanger, in fluid communication with a phase separator, in fluid communication with a gas turbo-expander, and in fluid communication with the fourth heat exchanger, where the operational flow rate from the main heat exchanger to the gas turbo-expander can be as low as about 1,450 lb/hr during continuous operation; a first expansion device in fluid communication with the main heat exchanger; a sub-cooling heat exchanger in fluid communication with the first expansion valve;a second expansion device in fluid communication with the sub-cooling heat exchanger; a pressure tank in fluid communication with the second expansion valve; a four-way valve in fluid communication with the pressure tank; the four-way valve in fluid communication with the sub-cooling heat exchanger and in fluid communication with the main heat exchanger;the gas turbo-expander in fluid communication with the phase separator, and in operational communication with an expander driven compressor; the expander driven compressor in fluid communication with a fifth heat exchanger; the fifth heat exchanger in fluid communication with second stage compressor; an ammonia absorption chiller in fluid communication with the prime mover, in fluid communication with the first heat exchanger, in fluid communication with the second heat exchanger, in fluid communication with the third heat exchanger, and in fluid communication with a cooling tower; a make-up water line in fluid communication with the cooling tower; and where the amount of liquid natural gas produced by this system while continuously running during a 24 hour day can be as low as about 6,000 liters per day, where the system has no more than two expansion valves; and where the first and second devices are selected from a group consisting of a compressor-loaded multi-phase expander turbine, and an expansion valve.

The invention also relates to a system for the small-scale production of cold compressed natural gas comprising: a natural gas supply, the natural gas having a pressure in a range of about 55 psia to about 350 psia; a prime mover in fluid communication with the natural gas supply, and in fluid communication with a third heat exchanger; a multi-stage compressor in operational communication with the prime mover; the multi-stage compressor comprising a first stage compressor, a second stage compressor, and a third stage compressor, and where the inlet temperature of fluid entering the first stage compressor is less than about 40° F., and where the inlet temperature of fluid entering subsequent stages of the compressor is less than 40° F.; a first inter-cooler in fluid communication with the first stage compressor and with a waste heat driven chiller; a molecular sieve in fluid communication with the first inter-cooler and in fluid communication with the natural gas supply; a fourth heat exchanger in fluid communication with the molecular sieve and in fluid communication with the first stage compressor; a second inter-cooler in fluid communication with a waste heat driven chiller and the second stage compressor; a first heat exchanger in fluid communication with the second inter-cooler, a waste heat driven chiller and in fluid communication with the third stage compressor; an after-cooler in fluid communication with the third stage compressor and with a waste heat driven chiller; a second heat exchanger in fluid communication with the after-cooler and with a waste heat driven chiller; a main heat exchanger in fluid communication with the second heat exchanger, in fluid communication with a phase separator, in fluid communication with a compressor-loaded gas turbo-expander, and in fluid communication with the fourth heat exchanger, where the operational flow rate from the main heat exchanger to the gas turbo-expander can be as low as about 1450 lb/hr during continuous operation; a first expansion device, such as a throttle valve or compressor-loaded multi-phase expander, in fluid communication with the main heat exchanger; a sub-cooling heat exchanger in fluid communication with the first expansion valve or compressor-loaded multi-phase expander; a pressure tank in fluid communication with the second expansion valve; a four-way valve in fluid communication with the pressure tank; the four-way valve in fluid communication with the sub-cooling heat exchanger and in fluid communication with the main heat exchanger; the gas turbo-expander in fluid communication with the phase separator, and in operational communication with an expander driven compressor; the expander driven compressor in fluid communication with a fifth heat exchanger; the fifth heat exchanger in fluid communication with one of the stages of a multi-stage natural gas compressor; an ammonia or lithium bromide absorption chiller or an adsorption chiller in fluid communication with the prime mover, in fluid communication with the first heat exchanger, in fluid communication with the second heat exchanger, in fluid communication with the third heat exchanger, and in fluid communication with a cooling tower; a make-up water line in fluid communication with the cooling tower; and where the amount of cold compressed natural gas produced by this system while continuously running during a 24 hour day can be as low as the liquid equivalent of about 6,000 liters per day, and where the system has no more than two natural gas expansion devices.

In addition, the invention relates to a method of dispensing natural gas from stored cold compressed natural gas, the method comprising: dispensing cold compressed natural gas from a cold compressed natural gas storage tank, with or without pumping it with a cryogenic liquid pump to a higher pressure; pumping the cold compressed natural gas by a cryogenic liquid pump to a pressure suitable for compressed natural gas dispensing and storage in on-vehicle compressed natural gas storage tanks; recovering cold from the cold compressed natural gas by heat exchange with natural gas feeding the natural gas production plant to replace dispensed product, such that the incoming, relatively warm, feed-gas warms the pumped-to-pressure cold compressed natural gas to a temperature of about −20° F. to about 30° F., thus converting it from cold compressed natural gas to compressed natural gas; where the refrigeration content of the outbound cold compressed natural gas is used to reduce the refrigeration needed to convert the incoming feed gas to more cold compressed natural gas or liquid natural gas; where the now warmed gas stream (formerly cold compressed natural gas) is cooler than standard compressed natural gas but can be stored in standard, non-cryogenic, on-board vehicle fuel storage tanks; thus allowing for a compressed natural gas dispensing facility that can achieve storability and off-peak production, and yielding a cooler than normal, and thus denser dispensed compressed natural gas, allowing for existing, standard on-vehicle compressed natural gas tanks to take away more product (as measured in pounds per cubic foot of fuel tank capacity), then is achievable with standard compressed natural gas at the same pressure but as warm as about 100° F.

Also, the invention relates to a system for the storage, transport, and dispensing of natural gas, comprising: means for handling natural gas in a cold compressed natural gas state where the natural gas is a non-liquid, but is dense-enough to allow for pumping to pressure by a cryogenic liquid pump; a means for optimally balancing the compression and refrigeration input required to produce the cold compressed natural gas; and a means for putting the natural gas into a cold compressed natural gas state without first putting the natural into a cryogenic liquid state which is subsequently pumped to a higher-than critical pressure.

### BRIEF DESCRIPTION OF THE DRAWINGS

The present disclosure will be better understood by those skilled in the pertinent art by referencing the accompanying drawings, where like elements are numbered and labeled alike in the several figures, in which:

FIG. 1 is a portion of a process diagram of the system;

FIG. 2 is the remainder of the process diagram of the disclosed system;

FIG. 3 is a flow chart illustrating one embodiment of the disclosed method;

FIG. 4 is a detailed process flow diagram of one embodiment of the disclosed method for the production of LNG;

FIG. 5 is a process flow diagram of another embodiment of the disclosed method for the production of LNG;

FIG. 6 is a process flow diagram of one embodiment of the disclosed method for the production of CCNG;

FIG. 7 is one embodiment of the disclosed method for the production and dispensing of CNG by way of LNG or CCNG production and storage;

FIG. 8 is a Phase Diagram of methane, which is an analog for the phase diagram of natural gas;

FIG. 9 is a flowchart showing one method of the invention; and

FIG. 10 is a flowchart showing another method of the invention.

### DETAILED DESCRIPTION

The disclosed process provides a means to produce, at small-scales, LNG at or near the vehicles that will be served by the facility. With on-site liquefaction inherent in the disclosed process, the LNG product need not be as cold as the LNG produced at distant, large-scale production plants. “Warmer” LNG requires less energy input than colder LNG, and LNG made at (or near) the vehicle fleet it serves will require less energy input for transporting the product. Similarly, if the main customer base is CNG vehicles, then the LNG used to dispense CNG (that system being known as L/CNG) need not be any colder than required for adequately storing and pumping the LNG to the pressure needed for CNG dispensing.

The inventor, who is an expert in this field, is not aware of any existing, commercially viable Small-Scale LNG plants anywhere in the world and is not aware of any CCNG production, storage or dispensing systems or of a CNG dispensing systems that includes CCNG production and storage. The smallest LNG plant that he is aware of, in the state of Delaware in the US, produces approximately 25,000 gallons (95,000 liters) per day. By contrast, the proposed invention will be viable at a production rate of only about 6,000 liters per day. That “small-scale” is an essential component of the business model for the invention, namely that it will provide vehicle grade LNG to a medium-sized bus or truck fleet, without requiring that a portion of the plant's output be shipped to a second and third, off-site fleet. In short, each small-scale LNG plant can act as an “appliance” that serves a single customer at a single location. Such small-scale LNG plants will also allow stranded gas fields (those not near pipelines, or too small for pipeline extensions) to be developed, allowing the produced LNG to be sent to off-site customers or to distant pipelines for re-gasification. Also, the invention allows for a wide range of “LNG products” from cold LNG (about −245° F. and colder), to warm LNG (between approximately −160° F. to about −240° F.), and to CCNG, which is dense-phase non-liquid state of natural gas that is colder than natural gas' critical temperature and is at a higher pressure than its critical pressure. That range of cryogenic natural gas conditions will have a density of approximately 15 to 20 pounds per cubic foot for CCNG and above about 25 pounds per cubic foot for LNG that is at about −245° F. and colder, with variation that depends on the methane and other hydrocarbon content of the natural gas.

CCNG is more than a “supercritical” phase of natural gas, with the single attribute of having a higher-than critical pressure. CCNG has the second attribute of being colder than the critical temperature of natural gas. It is those two attributes, together, that achieve its relatively high density (allowing it to be viably stored, much like LNG in readily available cryogenic storage tanks), and, most importantly, achieving the densities that allow that non-liquid (more than supercritical) phase of natural gas to be pumped to a higher pressure by standard cryogenic liquid pumps, as though CCNG were a liquid.

CCNG is not a liquid but will behave much like a liquid, allowing its pressure to be raised not only by compression (as is normally used for vapors) but also by pumping, as is used for all liquids. The pumping of liquids requires significantly less energy input than the compression of gases because liquids are virtually incompressible, allowing almost all of the energy input to accrue to raising the pressure of the liquid. CCNG is sufficiently incompressible, much like a liquid, to allow for efficient pumping. Thus a significant benefit of CCNG is the ability to raise its pressure (for example, for dispensing as CNG) by merely pumping it. An equally important benefit of CCNG is that the energy input required to produce it is lower than the energy input required to produce standard LNG, which is the standard form of dense-phase, storable and pump-able natural gas. (At temperatures as cold or colder than about −150 F and as the pressure of the LNG is raised above about 700 psia, it becomes CCNG. However, that methodology of producing CCNG, by pumping a liquid, requires more energy input than the methodology disclosed below.)

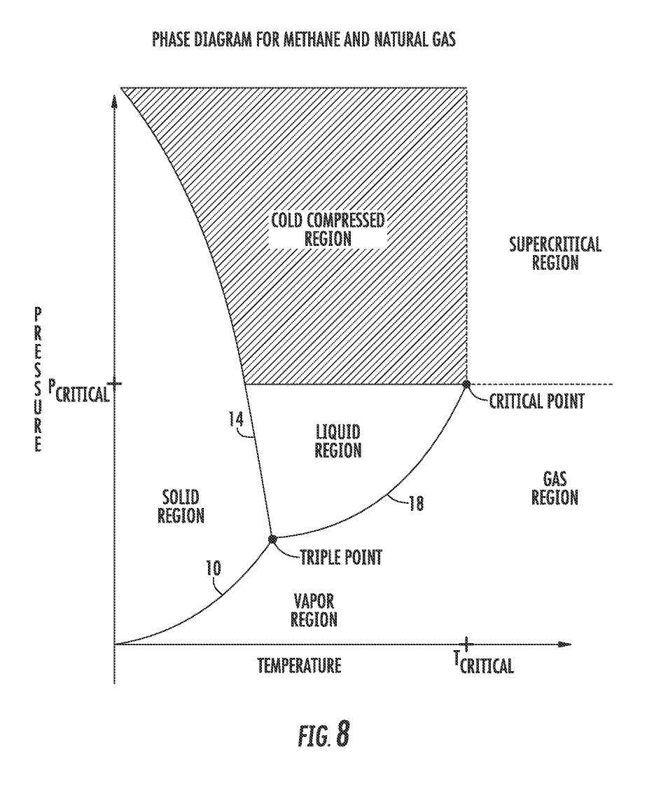

The common aspects of the wide-range of cryogenic natural gas conditions are the increased density, when compared to pipeline gas and to CNG, and the ability to pump such moderate-pressure cryogenic natural gas to any desired outflow pressure from the storage container, using standard cryogenic liquid pumps. Those attributes of storability and “pump-ability” are the main attributes of standard LNG. However, the present invention achieves those attributes at many warmer (and higher-pressure) conditions than for standard LNG. Those warmer and higher-pressure conditions require significantly less energy input than standard (cold and low-pressure) LNG, because cryogenic processes are more energy “sensitive” to the depth of refrigeration than to the pressure under which the gas is refrigerated. Thus, the present invention discloses the novel use of CCNG as a phase of natural gas suitable for the production, storage, transport, and dispensing of a variety of dense-phase natural gas products, including (but not limited to) vehicle-grade fuels. We say “phase,” rather than “state” or “condition,” because CCNG can be identified on a phase diagram of methane (and natural gas) shown at FIG. 8. FIG. 8 locates the CCNG range on the phase diagram for natural gas.

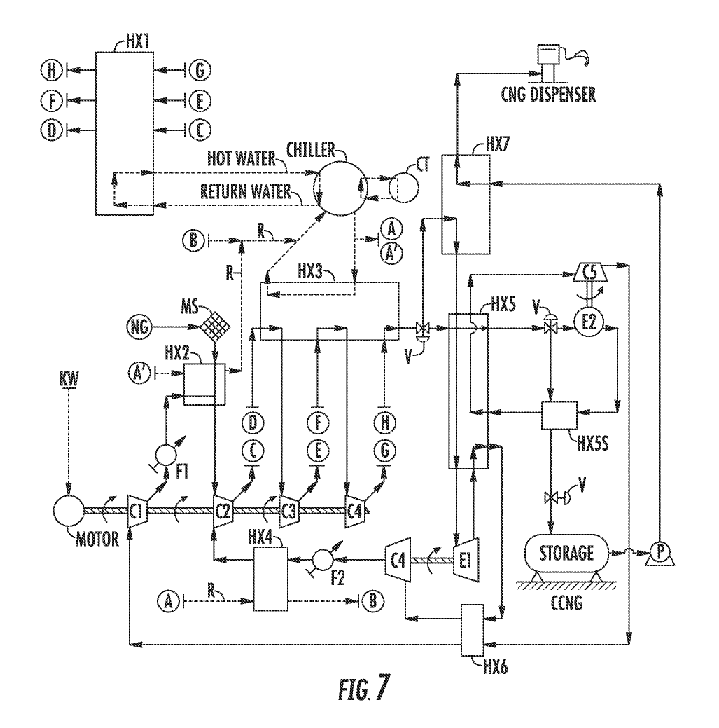

“Pump-ability” is an important attribute of cryogenic methane because often the stored cryogenic methane is dispensed as high-pressure, near-ambient CNG at pressures of approximately 3,000 to about 3,600 psia. Pumping LNG to such pressures, at L/CNG dispensing sites is routine, but is often wasteful of the refrigeration content of the LNG if there is no on-site liquefaction equipment or other cold recovery options. By contrast, the disclosed method allows for the pumping of non-liquid CCNG, and includes cold recovery, as illustrated in FIG. 7 and described in more detail below.

It should be noted that some cryogenic liquid pumps would easily tolerate the approximately 700-psia inlet pressure that is required for the pumping of CCNG. Other pumps, that can only tolerate, say, about 300 psia inlet pressures, can be used to pump CCNG if the CCNG is first expanded down to about 300 psia (causing most of it to become a liquid), and where that two-phase product of expansion is sent through a commonly available phase-separator. The smaller, vapor portion of that expansion can be further expanded down toward atmospheric pressure, producing more mostly liquid (suitable for pumping) and some vapor. Alternatively, the vapor portion of the first expansion and separation can be returned (cold) to the VX Cycle for re-compression. Thus, there are several practical and widely available techniques for pumping CCNG, much like a liquid, to any desired higher-pressure.

The ability to economically produce vehicle-grade LNG, CCNG or CNG dispensed from stored LNG or from CCNG will be achieved by at least two aspects of the invention: a) low capital costs, and b) high-efficiency. In one embodiment, the disclosed method offers, in a single deployment, the option of producing LNG, CCNG and CNG. LNG and CNG have an existing and growing vehicle fuel market as well as other non-vehicular uses. At the moment, the benefit of CCNG is that it is less costly to produce than LNG, but can be dispensed as a liquid (as discussed above) or, after cold recovery, as CNG. The dispensing and on-vehicle storage of CCNG as vehicle fuel is a plausible near term concept that only depends on certifications by US DOE and/or other such agencies, of the use of on-vehicle, composite, cryogenic pressure vessels (such as those that rely on outer wrappings of carbon fiber and other high-strength fabrics), which will tolerate the about −150° F. and colder and about 700 psia and higher pressure conditions of CCNG. Thus, the present invention offers an entirely new form of on-vehicle fuel—CCNG—that will have nearly the density of LNG, but which will not “boil off” because, as a single-phase fluid, any heat gain will only cause its pressure to rise. As such, an appropriately designed CCNG vehicle fuel tank will be lighter than an LNG tank, will not require space above the liquid for vapor to form, and will contain the product indefinitely, without “burping” methane.

The invention will allow an about 2,000-gallon/day LNG/CCNG plant to be constructed for less than about $2,000,000 The innovative LNG production cycle will yield approximately 83% LNG/CCNG out of every unit of natural gas that is delivered to the plant from the local low-pressure pipeline or stranded well, with only approximately 17% of the natural gas used as fuel for the prime mover. That combination of relatively low capital cost and low fuel use (high-efficiency) will yield an operating cost and “price per liter/gallon” that will allow the LNG/CCNG (or CNG that is dispensed from the stored LNG/CCNG) to be sold at a discount to the market price of diesel, accounting for the energy content (BTU) both fuels.

That achievement—competitively priced LNG/CCNG/CNG—will allow natural gas to be more than just an “alternative fuel” but also an economically viable alternative fuel.

The attached process flow diagrams illustrate the invention, which is known as the disclosed system. The invention is a unique and innovative variant of the methane expansion cycle, which to date, has only been deployed commercially in certain special, large-scale configurations, specifically known as “letdown plants”. Thus, the system described here is also known as Vandor's Expansion Cycle or the “VX Cycle”. It should be noted that the definition of CCNG offered above was included in U.S. Pat. No. 7,464,557 B2, which was co-invented by the inventor of the presently disclosed method. That prior invention is referenced here in its entirety. FIG. 8 shows the “position” of CCNG on a phase diagram for natural gas.

The disclosed method and system assumes that a low-pressure natural gas pipeline or stranded well is available adjacent to the fleet that will use the liquefied natural gas; that the natural gas is delivered at a pressure of about 60 psia or greater; at a temperature of approximately 60° F.; and with a chemical composition that is about 95% methane, with some N₂ and CO₂, but otherwise “clean”. In the event that the pipeline gas is not as clean, there are several known clean up systems that can be integrated with the disclosed method and system. In the event that the gas source is at a lower-than about 60-psia pressure, a small booster compressor can be used to raise its pressure, prior to entry into the main compressor. Alternatively, the first stage of the main compressor can receive the feed gas at whatever pressure above atmospheric that is available.

The low-pressure pipeline (or stranded gas well) stream is separated into a fuel stream that provides fuel to a natural gas fired “prime mover”, such as an internal combustion engine or a micro-turbine, and into a product stream to be compressed and liquefied. The use of natural gas as a fuel in a prime mover (an internal combustion engine or gas turbine) is well understood and is not claimed as an innovation. In contexts, such as California, where it may be difficult to obtain a permit for a natural gas fired prime mover, the disclosed method can function with a motor drive, with electricity delivered by the electrical grid. In that embodiment, the waste heat that would drive the chiller would be limited to the heat of compression that is produced in the multi-stage compressor. Depending on the configuration of the compressor, including the number of stages, the outflow stream from any single compressor stage may be hotter than about 280° F., which is more than adequate to drive a chiller that can produce worthwhile low grade (approximately 42° F.) refrigeration.

The first step in the liquefaction process is the removal of CO₂ and any water from the pipeline gas stream, in a multiple vessel molecular sieve, which requires periodic regeneration, where the regeneration gas (loaded with CO₂) is sent to the prime mover for use as fuel. This step is well understood in the industry and is not claimed as an innovation. The cleaner the pipeline gas the less complex the molecular sieve system and the less frequent the need for regeneration. Alternatives to molecular sieves include membrane separation technology and refrigerated methanol clean up systems. The disclosed method is neutral as to which CO₂ and water removal method is optimal for the particular scale and location at which the invention is deployed.

The cleaned, dry natural gas is sent to a multi-stage natural gas compressor, such as might be used at CNG stations, but likely smaller, because it will be operating 24-hours per day at a steady rate, rather than in the “just in time” mode of most CNG compressors. A novel aspect of the disclosed method and system is the use of a CNG station and/or standard CNG equipment to produce liquefied natural gas or CCNG, allowing for the upgrading of existing CNG stations, yielding an operating mode that includes off-peak production, on-site storage, fast fill during vehicle fueling, and the dispensing of a wider range of natural gas products, all of which are colder and denser than standard CNG

The disclosed method and system will allow existing CNG stations to be upgraded to LNG/CCNG production, by using the existing CNG compressors; and it will allow makers of existing CNG equipment to participate in the expansion of the vehicle-grade LNG industry. Thus, a widely deployed small-scale LNG/CCNG network need not displace all existing, well established CNG production and dispensing facilities, allowing for a smooth transition from low-density CNG to high-density LNG/CCNG, including the continued dispensing of CNG, say, to light-duty vehicles, but where that CNG is as cool as can be tolerated by existing CNG fuel tanks (say, about −20° F.) as compared to standard CNG which is almost always above ambient, say, at about 100° F. In other words, disclosed method allows for the stored LNG/CCNG to be dispensed as high-pressure CNG but at cooler temperatures than standard CNG, resulting in a denser product delivered to the on-vehicle fuel tank than can be accomplished with standard CNG dispensing. Note that the “cold content” of the stored LNG/CCNG does not need to be dissipated before it is dispensed to the non-cryogenic on-vehicle fuel tanks Rather, the outbound cryogenic LNG/CCNG is heat exchanged with incoming feed gas, warming the outbound, pumped-to-pressure LNG/CCNG to temperatures acceptable by the on-vehicle fuel tank, and thus pre-cooling the inbound natural gas feed stream to the VX Cycle equipment. That aspect of the disclosed system/method allows for the optimal temperature and density of the CNG but without wasting the refrigeration that was used to achieve the storability and pump ability of the LNG/CCNG.

The feed gas to the LNG plant will be compressed, in stages, from, about 60 psia to about 400 psia. That choice is an essential feature of the invention because pressures to about 3,600 psia are routinely provided by most CNG compressors. Operating a CNG compressor at lower pressures will reduce the compressor's workload and reduce the “heat of compression” that is absorbed by the natural gas. In some embodiments of the disclosed system/method, especially where the optimal product is CCNG at about −150° F. and colder and stored at about 700 psia and greater pressure, the feed gas may be compressed to above about 700 psia. That increase in compression work is a relatively minor manner when compared to the energy savings of not having to chill the natural gas down toward about −260° F., because for each degree of lowered temperature, the energy input required is exponential. By contrast, increasing the pressure of the gas from about 400 psia to about 700 psia, a less than about 2:1 pressure increase, requires only a modest extra amount of energy input.

The disclosed system has a preferred compression range of about 375 psia to about 710 psia, yielding a unique balance between compressor work in the front end and refrigeration output at the back end of the cycle. Note that the about 710 psia compression range is required only when CCNG is the optimal product. If warm LNG is the product, the lower-pressure range (about 400 psia) is adequate. Thus, each embodiment and deployment of the present invention will be calibrated to balance the refrigeration and compression input required to produce the desired product. That front-end compressor work includes the compression of a low-pressure recycle stream, whose pressure is directly related to the expansion of the about 400-to- about 700-psia natural gas stream to approximately 18 psia during the refrigeration process.

The single CNG compressor will perform two functions. It will be both the feed gas compressor and the recycle compressor. This is possible because the disclosed method and system is an “all methane” cycle, where the working fluid (refrigerant) and the feed stream are both methane. Both streams will be compressed simultaneously in a single CNG compressor. This is a major advance in LNG production, because the only LNG plants that use methane cycles are letdown plants, generally found at pipeline gate stations that serve large urban areas. However, letdown plants (by definition) do not require compression because they rely on high-pressure feed gas, and have the opportunity to send out large quantities of low-pressure natural gas into local low-pressure pipelines.

The disclosed method and system will use a uniquely integrated chiller to counteract the heat of compression and to pre-cool the CNG immediately after it exits the compressor's last stage after-cooler. That unique use of a well-established technology (absorption/adsorption chilling) is a second innovation of the invention, and is described in more detail below. In this disclosure the word chiller shall mean any non-mechanical chiller, such as an ammonia absorption chiller, lithium bromide absorption chiller, desiccant-based adsorption chiller, all of which are driven by waste heat rather than a motor.

Another novel aspect of the disclosed method and system is that the heat of compression will be mitigated, and the natural gas will be pre-cooled by refrigeration from a chiller powered by waste heat from the prime mover. In some embodiments of the disclosed method/system, the higher-grade portion of the heat of compression (from approximately 150° F. to above about 280° F.) is used to partially drive the chiller. Any remaining low-grade heat of compression contained in the gas stream is then dissipated in an inter- or after-cooler, prior to further chilling by the refrigerant produced at the chiller. Thus, the inlet temperature to each stage of compression (including the first stage) can be cooler than would be possible with inter-coolers alone. Those inlet temperatures can be reduced to at least about 50° F., and preferably down to about 30° F., substantially reducing the workload on each stage of compression.

The CNG compressor's inter-coolers (between stages) and after-cooler will be integrated with the chiller as outlined above. Thus, the gas streams that enter each stage of compression can be as cool as about 30° F. (or colder), increasing the density of the gas and reducing the workload on each compressor stage. (No freezing of the gas will occur because water and CO₂ are removed prior to compression.) Also, the inter-cooler between the first and second stage of the multi-stage compressor will heat exchange the CNG stream with the colder recycle stream, chilling the CNG on its way to the second stage, and warming the recycle stream on its way to the first stage. This is an example of cold recovery from the low-pressure recycle stream that leaves the heat exchanger at approximately −30° F.

The inter-cooler between the second and third stage will be cooled by the refrigeration output of the waste-heat driven chiller. The same chiller will cool the CNG stream in the compressor's after-cooler, and in a subsequent heat exchanger, down to as cold as about −22° F.

The chiller will be “powered” by the waste heat from the prime mover, recovering a significant portion of the approximately 67% of the energy content of the fuel used by the engine/turbine that is normally “wasted” by the engine's exhaust and water jacket or in the turbine exhaust. That recovered heat will increase the about 32%-35% thermal efficiency of the engine/turbine to a practical efficiency of approximately 43%, through the refrigeration output from the absorption chiller. In some embodiments, a portion the refrigeration output of the chiller can be used to pre-cool the inlet air to the turbine that drives the cycle, thus improving the efficiency of the turbine. The disclosed method and system seeks to use any recovered refrigeration at the earliest possible place in the cycle, reducing workload as soon as possible so that energy saving cascades through the process. Thus, when a turbine is the prime mover, the chiller's refrigeration output will first be used for cooling the inlet air to the turbine. Any remaining refrigeration will be used to cool the inlet gas streams to each compressor stage, with any remaining deep refrigeration used to cool the last stage outflow gas, prior to its entry into the main heat exchanger.

The integrations between the chiller and the compressor, as outlined above, will allow the “heat of compression” to be mitigated in each stage of the compressor and/or used to drive the chiller, improving the compressor's efficiency and allowing the CNG to exit the compression cycle pre-cooled to as low as about −22° F.

The pre-cooled CNG (at between approximately 400 psia and about 700 psia) will then be sent to a heat exchanger where it is further cooled, condensed, and (after several steps outside the heat exchanger) is sub-cooled and liquefied to produce liquefied natural gas, which will be sent to a cryogenic storage tank at an appropriate pressure (about 65 psia) and a temperature of approximately −245° F. Alternatively, the approximately 700 psia natural gas is cooled to only about −150° F. (or slightly colder) and is stored in a cryogenic storage tank at that pressure, as CCNG. As such, the cryogenic “product” of the disclosed method/system is dense enough (at approximately 15 pounds per cubic feet) for storage, and suitable for pumping to any desired pressure by standard cryogenic liquid pumps, even though the CCNG is not a liquid. The optimum pump choice, especially as to the inlet pressures to the pump, will be determined by the cost and efficiency of available equipment by various pump makers. As discussed above, some pumps will tolerate higher inlet pressures, while others will require a two-step approach that first expands the CCNG to a lower pressure, causing much of it to become a pump-able liquid, with the remaining vapor either returned for re-compression or expanded again.

The chiller will improve the cycle efficiencies in two ways. First, it will cool the compressors second-stage inlet stream. Second, it will reduce the “warm end loss” of the heat exchanger, turning it into “warm end gain”.

The cooling of the compressor inlet streams will result in approximately an about 10% reduction in compressor power usage. This feature alone will increase the efficiency of the prime mover from, about 33% to about 36.5%, or approximately 10 kW.

The chilling of the compressed feed gas will significantly reduce the stream's heat content (enthalpy), compared to the heat content of the returning low-pressure stream. That will happen because the feed gas will be compressed to nearly about 400 psia, in one embodiment, where its behavior is “non-ideal” (similar to a liquid's behavior), while the low-pressure recycle stream (at about 18 psia) will behave in a nearly “ideal” manner. Those conditions will reduce the expander's refrigeration requirement by approximately 15%, reducing power demand by another about 15 kW.

The total power reduction achieved (10 kW+15 kW=25 kW) for the production of LNG equals about 20%. At the scale of the disclosed method and system, that power reduction is important. The power required for CCNG production, will be further reduced by another approximately, 25%.

Another novel aspect of the disclosed method and system is that the three main components of the “front-end”—the engine, the chiller, and the CNG compressor—will be linked, each to the other two components, allowing standard CNG equipment to produce cold, moderate pressure CNG which is then further chilled to produce LNG or CCNG

The disclosed method and system, unique among LNG cycles, will harness the CNG compressor's power source for the chilling of the CNG. The same engine or turbine that powers the CNG compressor will (through waste heat) power the chiller. Also, the disclosed method and system is unique among LNG cycles in that it can produce CCNG, which has many of the same attributes as LNG (storability, transportability, pump-ability) but requires significantly less energy input.

That integration of the prime mover, chiller and compressor is unprecedented for a variety of reasons, including because all other commercial-scale LNG cycles are not dependent on the compression of low-pressure gas to CNG, and the subsequent condensing and liquefaction by expansion of the same (cooled) CNG.

The disclosed system exploits the limitations of low-pressure methane compression-to-expansion, without using refrigerants such as N₂, as in nitrogen expansion cycles; or “mixed refrigerants” as in MR cycles; or hydrocarbons, as in cascade cycles; and without the inefficiencies of high-pressure Joule Thompson cycles. The disclosed method and system will achieve a good degree of the efficiency available to turbo-expander (letdown) LNG plants, but at much smaller scales and at lower capital costs, and without the need for a high-pressure pipeline or a low-pressure outflow “sink”. Also, the disclosed system builds on the CCNG principles advanced in U.S. Pat. No. 7,464,557 B2 by providing a cost-effective way of producing CCNG and by enhancing the “cold recovery” innovations in that invention to the cold recovery from stored CCNG to dispensed CNG, as outlined above.

A significant portion of the product stream cannot be liquefied in a single run through the process and is sent back to the beginning of the cycle to be re-compressed, mixed with more (cleaned) natural gas from the pipeline (or stranded well), pre-cooled by the chiller and sent through the heat exchanger for liquefaction or CCNG production. This return stream (the recycle stream) gives up its cold in the heat exchanger (a form of cold recovery), contributing to the cooling and condensing of the portion of the stream that ends up as LNG/CCNG.

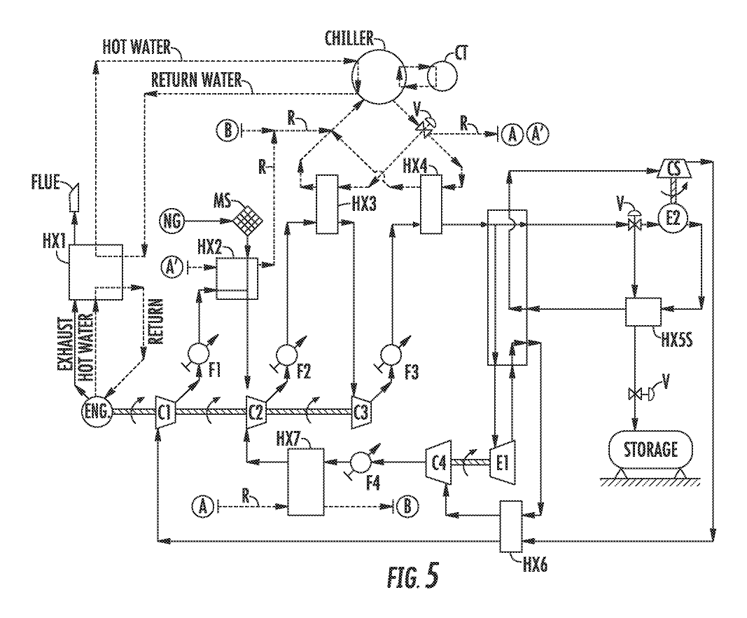

Another novel aspect of the disclosed method and system is that known refrigeration “producers”, such as JT valves and turbo-expanders are integrated at the “back-end” to convert the cold CNG produced in the front into LNG. An alternative, and preferred embodiment uses a compressor-loaded, (or generator-loaded or brake-loaded), multiphase, turbo-expander in lieu of a JT valve, (also known as a JT valve). That device is shown as E2 (for expander 2) and C5 (for compressor 5) on FIG. 5. Such a multiphase expander is also known as a Euler Turbine and as a Radial Turbine, as compared to Axial Turbines (or axial expander). The multiphase expander will, like the JT valve shown in FIGS. 5, 6 and 7, tolerate a reduced-pressure outflow stream that is partially a liquid and partially a vapor. However, the multiphase expander, because it is doing work (by, for example, being compressor-loaded), will yield more refrigeration output than the JT valve. That “extra” refrigeration will manifest in a larger portion of the outflow stream being liquid. In turn, the larger liquid portion will absorb more heat from the main natural gas stream that moves through the sub-cooling heat exchanger (HX5S on FIGS. 5, 6 and 7), because a cold liquid that is to be vaporized will absorb more heat from a counter-flowing warmer gas stream than would a cold vapor stream. The extra refrigeration thus achieved allows for several efficiency increasing adjustments to the cycle. For example, the stream that is sent to the multi-phase expander can be reduced in flow rate (reducing the recycle and re-compression duty), and still achieve the required amount of refrigeration. Or, the stream that is to be liquefied can be increased in flow rate because of the extra available refrigeration. Those familiar with the art of process design will select the optimal flow rates for each stream, capitalizing on the extra refrigeration produced by the multi-phase expander, compared to the refrigeration produced by a JT valve. Also note that the compressor-load (C5) on the multi-phase expander will re-compress the entire outflow from the multi-phase expander to an extent that will further reduce the workload of the main compressor. FIG. 5 shows the outflow from C5 moving through several heat exchangers (described below) and arriving at C1 to be boosted to a high enough pressure so as to be able to join the main feed gas stream that enters C2. Note that the above-described embodiment for an alternative to a JT valve is not the only alternative. For example, some axial expanders (compressor-, or brake-, or generator-loaded) can also tolerate some degree of liquid+vapor flow, and can be used in lieu of JT valves, producing more refrigeration than a JT valve under the same conditions.

In order to achieve about −250° F. LNG at about 65 psia, (or the about −150° F. CCNG at about 700 psia) significantly more refrigeration is needed than can be provided by the front-end chiller. Two sources of refrigeration are at work near the main heat exchanger.

The first refrigeration source is a JT valve, also known as a throttle valve, or preferably, as illustrated on FIGS. 5, 6 and 7, a multi-phase compressor-loaded expander, either radial or axial. When LNG production is the goal, the pre-cooled CNG at about 400 psia and about −22° F. is sent through the single heat exchanger where it is cooled to about −170° F. by the other streams within the exchanger. That combination of approximately 400 psia and about −170° F. allows for the use of a “plate fin” heat exchanger (rather than a more-expensive coil wound unit) and yields a worthwhile amount of refrigeration as described in the next paragraph. Thus, this novel aspect includes, in part, the selection of the about 400 psia and the about −170° F. temperature of the main stream, allowing a commonly available plate fin heat exchanger to “coordinate” and integrate the several refrigeration steps. When producing CCNG, the same equipment will operate with a pre-cooled CNG stream at just above about 700 psia which is cooled in the main plate fin heat exchanger (HX5 on FIG. 7) only to about −150° F. The portion of the about 700 psia stream that moves through the JT valve or (preferably) the multi-phase expander (E2 on FIGS. 5, 6 and 7) will have a refrigeration content that will chill a larger stream of CNG to about −150° F., thus requiring smaller recycle streams. In other words, more of the feed gas will be delivered as CCNG to the “storage” tank without any increase in energy input, thus improving the efficiency of the cycle. That result, is a concrete example of the benefit of producing CCNG as compared to producing LNG. In summary, the disclosed method/system allows for the optimal “phase” of natural gas, but always achieving storability, transportability, and pump-ability.

A portion of the about −170° F. (or about −150° F.) stream, at about 400 psia (or just above about 700 psia when CCNG is the intended product), is sent through the JT valve or preferably the multi-phase, compressor-loaded expander (shown as E2 and C5 on FIGS. 5, 6 and 7), which (by pressure letdown) yields approximately −254° F. vapor and liquid at a pressure of only about 19 psia. That cold vapor +liquid stream is used to sub-cool the portion of the stream (in HX5S on FIG. 5) that is still at about −150° F. to about −170° F. and about 400 to about 700 psia, cooling it to about −251° F. and still at about 400 psia if LNG is the intended product. If CCNG is the intended product, no sub-cooling is needed, and the purpose of the JT valve, or preferably the multi-phase expander, is to provide an optimal amount of refrigeration to bring the CNG to its about −150° F. (or colder) storage temperature. When LNG is the desired end product, the sub-cooled product is dropped in pressure to about 65 psia; forming LNG at about −250° F., which can be sent to the storage tank, without any “flash” (vapor) formation. This is an important point because if flashing were allowed, the vapor stream would need to be returned (after cold recovery) to the CNG compressor. Note that FIGS. 5, 6 and 7 show no vapor return stream because there is no flash produced. However, such a vapor return line may be included in the design, allowing any LNG “boil off” from the storage tank to be returned for re-liquefaction. Similarly, if the storage tank is designed to hold CCNG, and if the pressure of the tank increases significantly, due to heat gains, then such a vapor return line will allow the high-pressure CCNG to be returned to the system for re-cooling at approximately 700 psia.

For the sake of clarity, the sub-cooler 94 is shown in the process flow diagram as a separate heat exchanger. However, the sub-cooling task might occur in the single plate fin heat exchanger. On FIGS. 5, 6 and 7, the sub-cooler is noted as HX5S.

The low-pressure stream that cooled the main product stream in the sub-cooler will be sent back toward the beginning of the process as part of the recycle stream. Prior to its return trip through the single heat exchanger, the recycle stream will be joined by a recycle stream from the second refrigeration source, a two-stage cryogenic methane turbo-expander 110. The combined recycle stream, while low pressure, will be cold enough to substantially cool the main process stream to say, about −140° F. (when CCNG is the goal) to about −170° F. when LNG is the goal. The balanced use of a cold, low pressure recycle stream to achieve fairly deep refrigeration of the “moderate” pressure main stream, is yet another novel aspect of the disclosed method and system. That balance is especially efficient when the intended product is CCNG, which requires only slightly more compression work than LNG but significantly less refrigeration input. Thus, the production of CCNG by way of the disclosed method and system allows for the optimal phase of vehicle-grade cryogenic methane, achieving all the benefits of standard (cold) LNG but with significantly reduced energy input. Indeed, the energy input required to achieve CCNG will be nearly as low as the energy input required to produce CNG, but the product will be significantly more valuable because of its storability, (allowing for off-peak production) and because it will always be dispensed cooler and denser, even when dispensed as CNG.

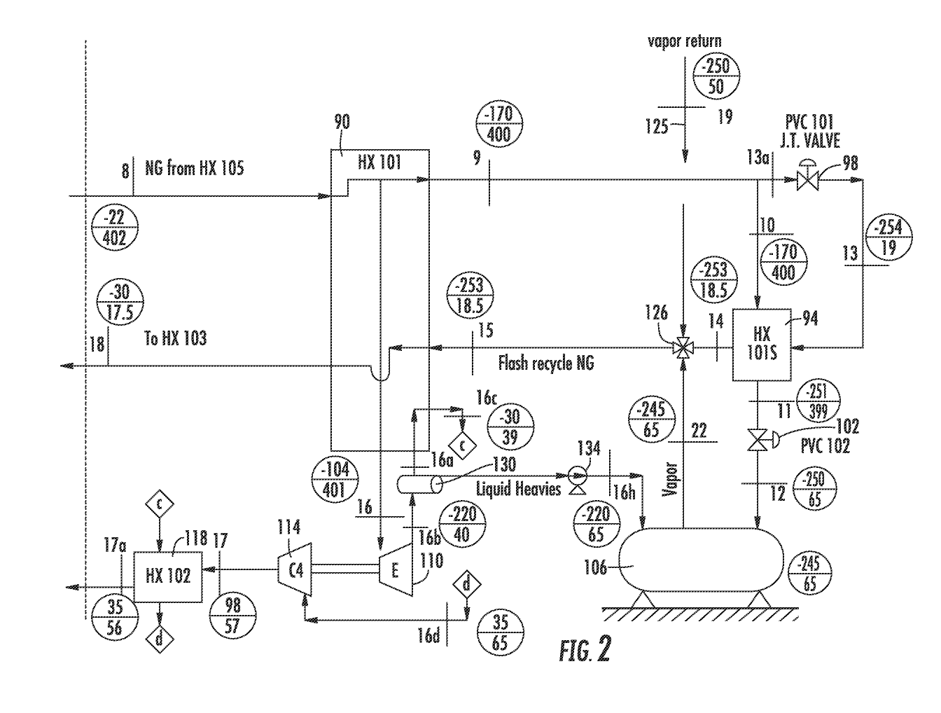

The second source of refrigeration, the turbo expander 110 on FIG. 2 and shown as E1 on FIG. 5, is needed because the letdown effect through a JT valve or the multi-phase expander alone does not provide enough refrigeration to produce CCNG or LNG. The cryogenic methane expander (E1) will convert cold CNG to colder, lower-pressure natural gas by doing “work”. The work can be recovered in an integrated compressor, shown as C4 on FIGS. 5, 6 and 7. If recovered, the “work” output of the expander (several kilowatts) can be applied toward the re-compression of the recycle stream, further reducing the workload of the CNG compressor and the need to fuel the prime mover. Thus, in a preferred embodiment of the disclosed method and system compressor-loaded expanders are located in two places in the cycle, E1 and E2 on FIGS. 5, 6 and 7. The distinction is that cryogenic methane expanders, which can tolerate large flow rates, do not tolerate the formation of any significant amount of liquid at the outflow from the expander. By contrast, JT valves, the preferred (radial) multiphase-expander, and specially designed axial expanders will tolerate liquid formation. Thus, the use of two expansion devices balances the optimal characteristics of those devices, with the cryogenic methane expander taking the larger flow rate but without any significant liquid outflow, while the other expander takes a lower flow rate but tolerating a higher percentage of liquid outflow. Those two devices, along with a chiller (which provides pre-cooling) constitute the refrigeration equipment in the cycle. Both expanders work on methane (rather than, say N₂), which is the same methane that becomes the stored CCNG or LNG. That approach limits the need for refrigerants and provides a favorable relationship (methane to methane) between the refrigerant and the gas stream to be chilled.

The methane expander receives that portion of the main stream from the heat exchanger (HX5 on FIGS. 5, 6 and 7) that did not travel toward the JT valve or multi-phase expander.

That second stream will leave the heat exchanger at approximately −90° F. to about −104° F., and approximately 400 psia and will be expanded in the cryogenic expander to approximately 40 psia, and thus cooled to approximately −220° F. (when LNG is the desired product); sent back to the heat exchanger for “reheat” (cooling the other streams in the heat exchanger); exiting the heat exchanger at about 39 psia and about −30° F.; giving up its “coldness” to the warm outflow stream from the compressor that “loads” the expander; entering that compressor at approximately 35° F. and about 38 psia; and returning to the second stage of the main compressor for further compression. When CCNG is the desired product the pressure of the gas streams is slightly above about 700 psia but the gas streams need not be cooled to colder than about −150° F. (However, if the CCNG is to be transported, it may be cooled to a colder temperature in anticipation of some heat gain during transport.)

The JT valve, multi-phase expander and the cryogenic methane expander all function well with the about 400-psia to about 700 psia inlet pressures. When LNG is the desired product, a higher than about 400-psia pressure might yield slightly more refrigeration at the JT valve or multi-phase expander, but not enough to warrant a more expensive heat exchanger and the need for more work by the compressor. The about 400 psia is a “comfortable” inlet pressure for a small expander. In short the selected conditions constitute a “sweet spot” in the efficient small-scale production or LNG yielding an excellent balance between refrigeration produced, the size and temperature of the recycle stream, the workload of the compressor, and the total amount of LNG produced per unit of fuel required to run the compressor. When CCNG is the desired product the work required to produce the extra pressure is more than offset by the lowered refrigeration requirement. If the cryogenic expander is most “comfortable” operating with about 400 psia inlet gas, then that portion of the gas stream that is sent to that expander can be withdrawn from the main compressor at that pressure, and the remaining portions can be further compressed to just above about 700 psia and directed to the main heat exchanger as outlined above. That optimization will require “extra” compression for only a portion of the throughput of the compressor.

The JT or multi-phase expander effect, the sub-cooler and the expander reheat cycle outlined above are all known in the industry. What is unique is the application of those individual techniques to a small-scale LNG plant in a specific, optimal manner. The disclosed method and system uses the main CNG stream as a “working fluid” (refrigerant) to liquefy a significant portion of itself, returning a “recycle” portion for re-compression, but only after several “cold recovery” steps. Also, the disclosed method and system offers a wide-range of cryogenic methane products, all dense enough for cost-effective storage (and thus, off-peak production), and pump-ability. At the warm end, CCNG production by the disclosed method and system achieves those benefits with the lowest possible energy input, rivaling the energy input required for ordinary CNG production.

The pre-cooling by absorption/adsorption refrigeration captures the waste heat of the engine (and/or the heat of compression) and delivers a significant amount of refrigeration to the CNG compressor without any additional fuel use. That pre-cooling step is illustrated on FIG. 5 as follows: The chiller is driven by hot water that is heated in HX1 by engine (ENG) exhaust and by the hot water from the engine's water jacket; the hot water that is sent to the chiller is returned to HX1 for further heating after it gives up its heat content to the chiller; the waste heat produced by the chiller is dissipated in a cooling tower (CT); the refrigerant produced by the chiller (ammonia or water) is sent to HX4, HX3 and to HX7 (via point A and B), and returns to the chiller warmer, and ready for re-chilling. The CNG compressor will be well within its capacities in its effort to compress a recycle and feed-gas stream to about 400 psia to about 700 psia. Fin-fan coolers F1, F2, and F3 are shown on FIG. 5, allowing the heat of compression to be dissipated so that the gas streams can enter HX2, HX3 and HX4 at near ambient, thus reducing the cooling load in those heat exchangers. Similarly, F4 dissipates the heat of compression from C4, reducing the cooling load in HX7. (Optimally, a single Fin-Fan unit, receiving multiple gas steams would be used, rather than many individual units.) The JT valve or multi-phase expander and sub-cooler will produce the LNG/CCNG relatively efficiently because the product stream sent to that device will be cold enough (about −140° F. to about −170° F.) to yield LNG by sub-cooling or CCNG. That cold stream to the JT valve will be available because the expander will produce natural gas as cold as about −220° F. at the appropriate flow rate for either LNG production or CCNG production. The addition of “compressor loading” to the cryogenic methane expander and to the smaller multi-phase expander (C4 and C5, respectively on FIGS. 5, 6 and 7) will further reduce the workload on the CNG compressor and the fuel required by the prime mover.

The recycle stream will be lower in volume than found in alternative LNG cycles because of the combined effect of the front-end absorption chiller; the moderate pressure, cold JT valve or multi-phase expander; the sub-cooler; and the cryogenic methane expander. This is especially true when CCNG is the desired product. The smaller recycle stream, will allow the compressor to do less work, requiring less power output from the prime mover, which in turn will use less fuel, reducing the plant's fuel use relative to the total output of LNG/CCNG to levels matched only by much larger LNG plants.

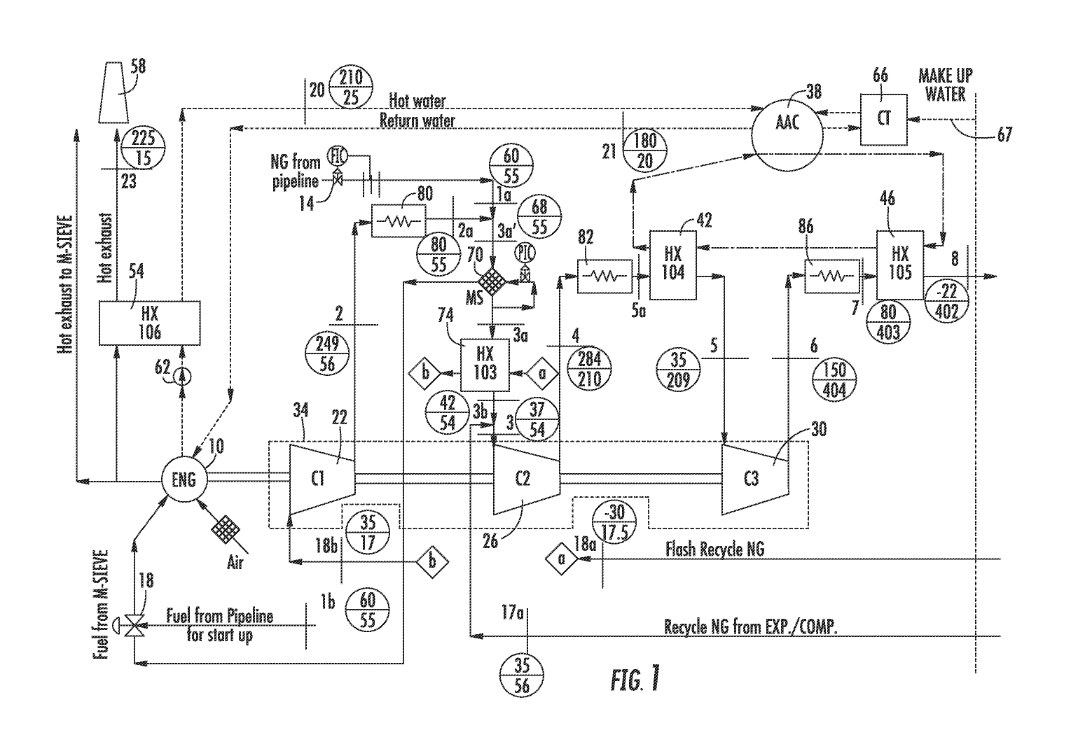

FIGS. 1 and 2 show schematic diagrams of one embodiment of the system for a small-scale production of LNG from low-pressure pipeline gas. The right side of FIG. 1 connects to the left side of FIG. 2. The approximate temperatures and pressures at various points are shown in circles, with the temperature on top, and the pressure at the bottom. Low-pressure (about 60 psia or greater) is the feed gas that will be used, in small part as the fuel for the prime mover 10, and will in large part be liquefied. A first inlet valve 14 near point la is the inlet connection from an adjacent natural gas pipeline (or from another natural gas source, such as a “stranded” gas well). A second inlet valve 18 is also an inlet connection from an adjacent natural gas pipeline (or from another natural gas source, such as a “stranded” gas well). This allows for a portion of the pipeline-delivered natural gas to be directed to the engine 10 during times such as: during start up of the plant, or to the clean up and liquefaction cycle beyond point 1a.

The prime mover 10 may be an internal combustion engine fueled by natural gas. A micro-turbine may also be used as the prime mover 10. The prime mover 10 directly drives a multi-stage compressor 34 comprising a first stage 22, second stage 26, and third stage 30. Variations on the number of stages are possible, as are methods for transferring the power of the prime mover to the compressor. Those variations will not impact the core methodology of the disclosed invention and may be selected on the basis of capital costs, equipment availability, and other “optimization” factors.

Waste heat from the prime mover 10 is used to heat the regeneration gas in the molecular sieve clean up system, discussed bellow. Waste heat is also used as an energy source in an ammonia absorption chiller 38, shown simply as a circle, which provides cooling to the compressor's second inter-cooler 82 and after-cooler 86, at the first heat exchanger 42 and second heat exchanger 46, which will be discussed in more detail below.

The waste heat from the prime mover 10 is delivered to the ammonia absorption chiller 38 by piping that extends the prime mover's jacket water system (not shown for clarity), which normally cools the engine. That hot jacket water is further heated by hot engine exhaust in the third heat exchanger 54. The engine exhaust gas is then sent to a flue 58 at about 225° F. A catalytic converter may be located at the appropriate place in the engine exhaust outflow system. A water pump 62 is shown just prior to the hot water's entry into the third heat exchanger 54. The pumping of the water with pump 62 to pressure will keep it from boiling. The hot water stream and the return stream from the ammonia absorption chiller 38 are shown as dotted lines on the process flow diagram.

The configuration of the ammonia absorption chiller 38, and its rejection of low-grade waste heat is a well-known technology. The process flow diagram does not show the internal process for the ammonia absorption chiller, but does show a cooling tower 66, which uses water as the cooling medium, disposing low-grade waste heat to the atmosphere. That cooling tower 66, in fluid communication with a make-up water line 67, also helps cool the compressor's inter- and after-coolers 80, 82, 86.

Point 3a′ is the location where the inlet natural gas stream from the pipeline (or stranded well), at approximately 60 F and about 55 psia, is mixed with a clean re-cycle stream (about 80 F, about 55 psia) that arrives at that point from down-stream process points that will be described in subsequent sections of this narrative.

The first significant step in the liquefaction process is the clean up cycle, which is well understood by those in the natural gas processing field, especially related to natural gas that is delivered from a pipeline, known as “pipeline quality natural gas.” Most pipeline gas contains some amount of CO₂ and water, which need to be removed prior to liquefaction; otherwise ice will form down stream in the process, causing the cycle to “freeze up”.

A molecular sieve 70 is configured to remove CO₂ and water from the natural gas in an adsorbent such as, but not limited to, zeolyte. The molecular sieve 70 does not remove any heavy hydrocarbons from the natural gas feed stream. That portion of the clean up cycle, if required, occurs near point 16a, and will be discussed below. The molecular sieve 70 may be a multi-vessel system that regenerates the adsorbent beds by using heated natural gas as the “purging” fluid. The resultant CO₂ laden regeneration gas is sent from the molecular sieve 70 to the prime mover 10 as fuel.

The process flow diagram does not show the configuration of the molecular sieve 70 system, nor the detailed piping and valves that control the delivery of hot exhaust gas to warm the regeneration stream, because that technology is well understood and is not an innovation of this invention.

At point 3a, the feed gas stream (at about 68° F., 55 psia) consists of the cleaned “make up” stream from the pipeline (or stranded well) and the recycle stream that joined it at point 2a. The reason clean recycled gas is mixed with pipeline gas, prior to the molecular sieve 70, is to reduce the CO₂ and water load on the mole sieve, by “diluting” the stream's CO₂ and water content. The stream arriving at point 2a is the outflow of the first stage compressor 22. The purpose of the first stage compressor 22 and the source of the “flash recycle” stream that it compresses will be discussed below. The stream arrives at point 2a after going through a first inter-cooler 80

The first cooling step in the LNG production process occurs through the fourth heat exchanger 74. The fourth heat exchanger 74 allows the about −30° F. “flash recycle stream” to chill the cleaned gas to about 42° F., as shown at point 3b. The slightly cooled main gas stream is mixed with a recycle stream from a natural gas expander's 78 (located on FIG. 2) outflow from point 17a. That recycle stream is arriving at point 3b at about 35° F. The combined natural gas stream, at point 3, now consists of the make up stream from the pipeline, the flash recycle stream and expander 78 recycle stream. The temperature of the stream at point 3 will be about 37° F. Note that the pressure of the stream drops slightly as it moves through piping and heat exchangers.

The combined stream enters the second stage compressor 26 at about 54 psia for compression, and leaves the second stage compressor 26 at about 210 psia. The heat of compression warms the natural gas stream to about 284° F., as shown at point 4.

Natural gas at about +284° F. and about 210 psia will be called warm CNG. The warm CNG is sent to an inter-cooler 82 (which is cooled by water from the cooling tower 66) and then on to the first heat exchanger 42 where it is further cooled by the refrigerant stream from the ammonia absorption chiller 38. The cooling water inflow and outflow from the inter- and after-coolers are not shown, because that aspect of the process is well understood by those familiar with gas processing and the workings of gas compressors.

The natural gas stream exits the first heat exchanger 42 at about 35° F. and about 209 psia, as shown at point 5. It then enters the third stage compressor 30 for additional (and final) compression, leaving the third stage compressor 30 at about 150° F. (due to the heat of compression) and approximately 404 psia. The warm CNG travels to the after-cooler 86, exiting it at about 80° F. and then on to the second heat exchanger 46 where it is further cooled by the refrigerant from the ammonia absorption chiller 38 to about −22° F. The entire purpose of the waste-heat driven ammonia absorption chiller 38 is to chill the natural gas stream during its trip through the second and third stages 26, 30 of the compressor 34, and to deliver the natural gas, pre-cooled to about −22° F., to the plant's main heat exchanger 90 (shown on FIG. 2).

The main heat exchanger 90 is the main heat exchanger for the disclosed system. The sub-cooling heat exchanger 94 may be integrated into heat exchanger 90 or may be a separate heat-exchanging unit as shown. The pre-cooled CNG enters the heat exchanger 90, traveling from point 8 toward point 9. However, it is split into two streams, one going to point 9 and one to point 16. The stream that moves to point 9 arrives there at about −170° F. as LNG at moderate-pressure, having been chilled by the counter-flowing stream in the main heat exchanger 90.

The moderate-pressure LNG moves from point 9 toward point 13, but is split into two streams, one of which moves through the first expansion valve 98 (also known as a JT valve), with the other portion moving on toward point 10. The first expansion valve 98 causes the LNG to become a two-phase (mostly liquid and less than about 30% vapor) stream, arriving at point 13 at about −254° F., but “letdown” to at a substantially lower pressure of only 19 psia. This stream's function is to act as a refrigerant on the main stream that is chilled to become LNG. Refrigeration occurs in a sub-cooling heat exchanger 94 as the liquid portion of the stream vaporizes and transfers its “coldness” to the about −170° F. LNG counter-flowing through the sub-cooler. The vaporization of the refrigerant stream does not change its temperature during that phase shift from liquid to vapor, allowing the vaporized refrigerant stream to move on to points 14 and 15 at approximately −253° F., ready to impart further cooling in heat exchanger 90, as described below.

That cryogenic two-phase “refrigerant” stream, described above, is sent through sub-cooling heat exchanger 94 (a sub-cooler) where it cools the “product” stream arriving from point 10 (about −170° F., about 400 psia) to become LNG, arriving at point 11 at about −199° F. to approximately −251° F. by the time the product reaches point 11. The about 399 psia LNG is then dropped in pressure through another expansion valve 102 arriving at point 12, and subsequently sent to the LNG storage tank 106, at the design pressure of that tank. In the embodiment shown in FIGS. 1 and 2, the tank pressure is about 65 psia. Other storage pressures will also work. The extent of “sub-cooling” of the stored product is related to pressure at which the product is stored in the LNG storage tank. In this context, sub-cooling may be defined as the extent to which the stored product is colder than the temperature at which it will boil, at its storage pressure. Lower storage pressures require colder LNG in order to prevent boil off and flash losses, due to heat gain. Thus, sub-cooling of the stored LNG is a strategy that limits (or substantially eliminates) vaporization of the stored LNG due to unavoidable heat gain to the insulated storage tank.

Returning to the “refrigerant” stream that exits the sub-cooling heat exchanger 94, it arrives at points 14 and at 15 at approximately −253° F. and moves on for additional “cold recovery” in heat exchanger 90, leaving the main heat exchanger 90 at approximately −30° F., as indicated by the values shown at point 18 and 18a. The remaining cold is further recovered in the fourth heat exchanger 74, as discussed above. The relatively warm stream (about 35° F.) arrives at point 18b at just about 17 psia. Thus, the function of the first stage compressor 22 is to recompress this (clean) stream so that it can return to the cycle and join the make up stream after point 2a, as discussed above.

Returning to the stream that entered heat exchanger 90, and was split into two portions, we can now follow the portion that arrives at point 16. Its trip through heat exchanger 90 allowed the about −22° F. inflow stream to be chilled by the other streams in the heat exchanger, so that it exits heat exchanger 90 at between about −90° F. to about −105° F. (the “warmer” the exit stream, the less energy was spent on cooling it.) This stream is also a “refrigeration” stream, providing the bulk of the refrigeration required to cool the product stream. The, say, about −100° F. CNG (at approximately 400 psia) is sent to a turbo-expander 110 that substantially cools the stream by expanding it to about 40 psia, and by having the turbo-expander 110 “compressor loaded” (by an expander driven compressor 114) so that “work” is performed. It is the expansion process, including the work performed, that achieves the dramatic cooling of the CNG.

The exit stream from the turbo-expander 110E will be approximately −220° F. and about 40 psia (see point 16b), allowing the natural gas stream to separate into heavy hydrocarbon liquids (such as ethane, and butane) and a nearly pure methane stream in a phase separator 130, shown near point 16a. That phase separation will take place if the feed gas contains any such heavy hydrocarbons. In that event, the liquid heavies are sent through a pump 134, to increase the stream's pressure (see point 16h), and then sent into the storage tank 106 to join the main liquid product of the process, the liquefied natural gas. The exact location of where the liquid heavies enter the tank can vary, and is subject to engineering decisions related to the mixing of the slightly warmer heavy hydrocarbon liquids with the larger and colder LNG, that will not impact the basic aspects of the disclosed system. Note that the small heavies stream, which is approximately at −220° F. will slightly warm the contents of the LNG tank, even though it is receiving LNG at approximately −250° F. On the other hand, if the feed gas to the cycle contains very little or no heavy hydrocarbons, such slight warming will not occur. For feed gas streams with a higher concentration of heavy hydrocarbons, or where the product LNG is used by vehicles that cannot tolerate any significant heavy hydrocarbon content in the LNG, some portion of the heavies from the phase separator may be sent as fuel to the prime mover. In short, the disclosed system can tolerate a variety of feed gas compositions, including from pipelines and stranded wells, and variety of product specifications for the LNG.

Continuing the process at 16a, the very pure methane stream, at about −220 F is a refrigerant stream that helps cool the stream that went from point 8 to 9 and the stream that went from point 8 to point 16. In this manner, (and by way of the sub-cooler previously described), the pre-cooled (about −22° F.) about 400 psia CNG is both a “product” stream (beyond points 10, 11, and 12) and a refrigerant stream. This aspect of the disclosed system is a unique version of a “methane expansion” cycle and is a core element of the innovation.

The outflow stream from the turbo-expander 110 leaves the heat exchanger 90 at about −30° F. and serves to mitigate the heat of compression as the same (about 39 psia) stream is sent through the expander driven compressor 114 that “loads” the turbo-expander 110. That “cold recovery” occurs in a fifth heat exchanger 118, allowing the expander 110 recycle stream to enter the expander driven compressor 114 at a “warm” state of about 35° F., exiting the expander driven compressor 114 at about 98° F., and exiting the fifth heat exchanger 118 at about 35° F., having dealt with the heat of compression. One optimization of the disclosed system may include a water-cooled after-cooler immediately after the expander driven compressor 114, before point 17, allowing the temperature of the stream to be cooler than now shown at point 17a, all of which is included in the scope of the disclosed system. Other optimizations will be obvious to those familiar with natural gas processing, but without impacting the core aspects of the innovative methane expansion cycle disclosed here.

It is the work performed by the expander driven compressor 114 that allows the expander 110 recycle stream to be returned to point 3b at about 56 psia, so that it can enter the second stage compressor 26 at a moderate pressure, rather than the first stage compressor 22 at a lower pressure.

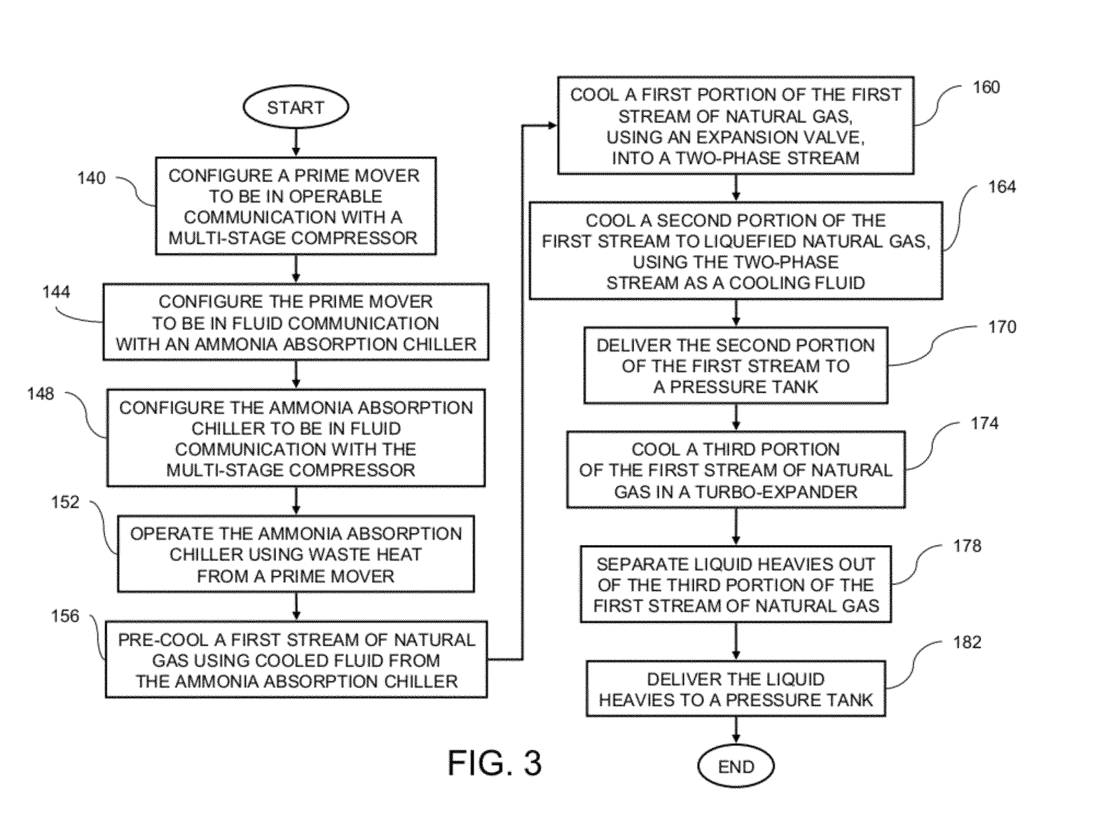

FIG. 3 shows a flowchart showing a disclosed method of the invention. At act 140 one configures a prime mover to be in operable communication with a multi-stage compressor. At act 144 one configures the prime mover to be in fluid communication with an ammonia absorption chiller. At act 148 one configures the ammonia absorption chiller to be in fluid communication with the multi-stage compressor. At act 152 the disclosed system operates the ammonia absorption chiller using waste heat from a prime mover. At act 156 the system pre-cools a first stream of natural gas using cooled fluid from the ammonia absorption chiller. At act 160 the system cools a first portion of the first stream of natural gas, using an expansion valve, into a two-phase stream. At act 164 the system cools a second portion of the first stream to liquefied natural gas, using the two-phase stream as a cooling fluid. At act 168 the system delivers the second portion of the first stream to a pressure tank. At act 172 the system cools a third portion of the first stream of natural gas in a turbo-expander. At act 176 the system separates liquid heavies out of the third portion of the first stream of natural gas. At act 180 the system delivers the liquid heavies to a pressure tank.

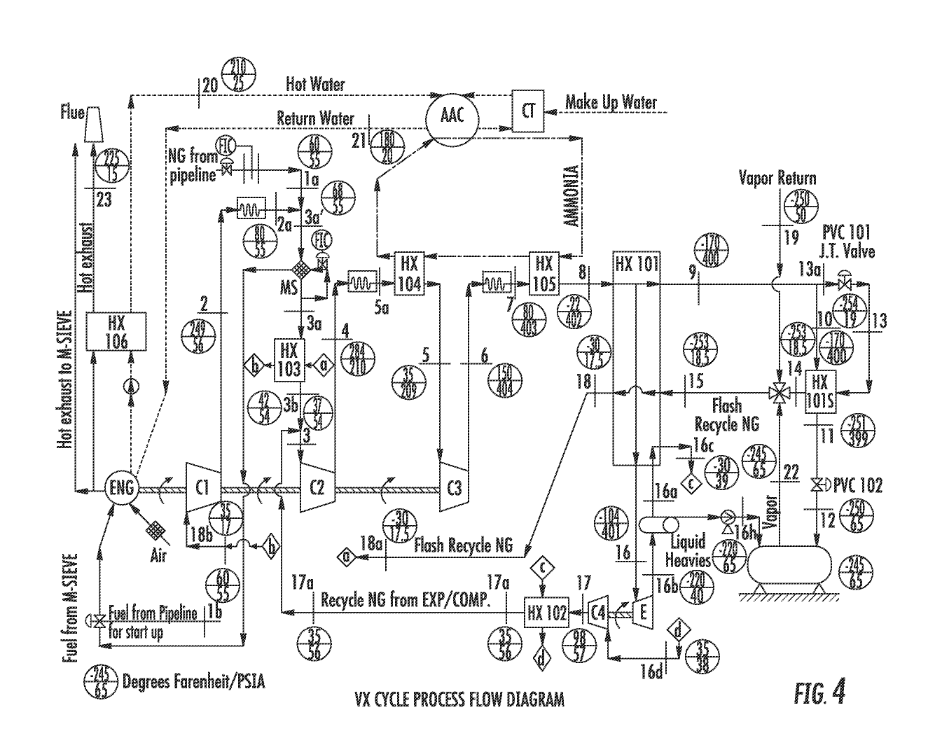

FIG. 4 is one of many possible embodiments of the disclosed system and method, showing the key components, flow streams, and approximate temperatures and pressures for the production of LNG at about −245° F. and about 65 psia. (Temperatures in Fahrenheit are shown in the upper part of the circular notations with pressures in psia shown in the lower portion of each circle.)

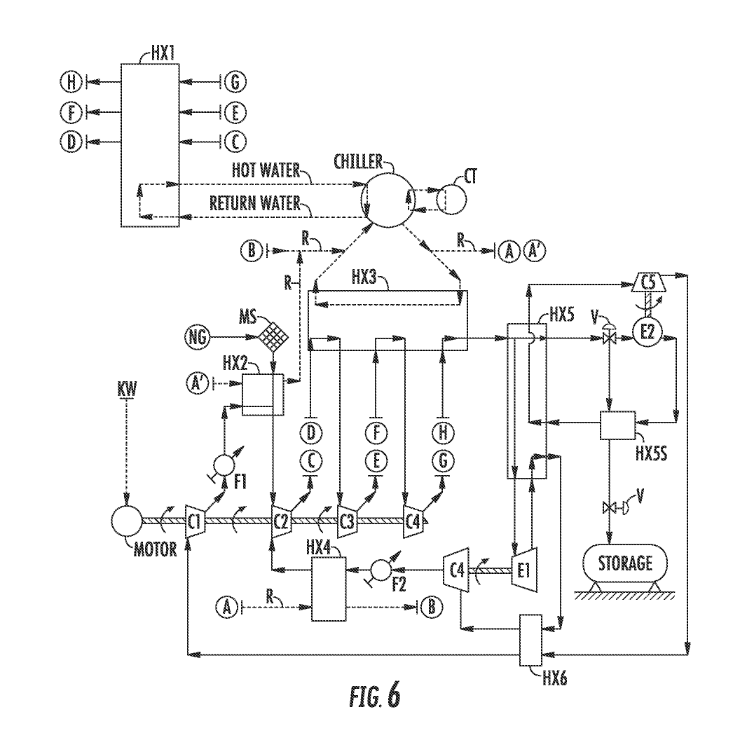

As discussed above, several features of the disclosed method and system can be optimized. The following are examples of such adjustments and are generally illustrated on FIGS. 5 and 6: a) The Ammonia Absorption Chiller (AAC) shown near point 21 on FIG. 4 can be replaced by a Lithium Bromide Absorption Chiller or by a desiccant based Adsorption Chiller or any other non-mechanical, waste heat driven chiller, shown as “chiller” on FIGS. 5 and 6; b) The JT valve shown near point 13a on FIG. 4 can preferably be replaced by a multi-phase axial or radial expander that can be compressor-loaded (or brake- or generator-loaded), where the compressor is driven by that expander (both on a single shaft) and where that compressor acts to recompress some or all of the expander output to a pressure suitable for insertion into stage one of the main compressor, shown as E2 and C5 on FIGS. 5 and 6; c) The main compressor, shown as C1, C2 and C3, can have more stages, especially if the desired product is CCNG, as illustrated on FIG. 6, where the outflow from the last stage (a fourth stage on FIG. 6) needs to be somewhat higher (to allow for subsequent pressure drop) than about 700 psia; d) the engine or engine-driven generator, also known as a “gen-set” (shown as “ENG”) can be replaced with a turbine (mini- or micro- for small scale deployments, or turbine-driven gen-set) which is not shown on any figure, and in that event, the heat source to HX 106 on FIG. 4 (or HX1 on FIG. 5) will only be the hot turbine exhaust, with no hot water as a heat source, (the total heat from the turbine will be as much or greater than the combined heat from the engine's exhaust and water jacket); e) The engine or turbine (or gen-sets) can be replaced by an electric motor powered of the electric grid, as shown on FIG. 6, allowing the cycle to be entirely free of emissions; e) The liquid heavies separator shown near point 16h on FIG. 4 will not be needed if the feed gas to the system is pipeline quality, and is not shown on FIGS. 5 and 6; f) The molecular sieve (MS) shown near point 3a on FIG. 4, and near HX2 on FIGS. 5 and 6 can be any one of several CO₂ and water removal systems, as discussed above; g) The vapor return line shown near point 19 on FIG. 4 can be from a vehicle's fuel tank where “flashing” may occur if LNG is dispensed into a nearly empty (warm) tank, and/or that vapor can be the vapor portion of expanded CCNG, prior to its pumping to pressure as CNG, as discussed above, and that vapor return line is not shown on FIGS. 5 and 6 so as to keep the graphics simple; i) The flue shown near point 23 on FIG. 4 and near HX1 on FIG. 5 would not be required if the prime mover were an electric motor (as indicated on FIG. 6), in which case the cycle would be a zero-emission process. In an attempt to keep FIGS. 5 and 6 relatively simple, the streams that will regenerate the mole sieve are not shown (as they are on FIG. 4), because such mole sieve regeneration systems are well understood by those versed in the art and science of gas clean up. FIG. 6 illustrates yet another embodiment of the invention, where the heat of compression between compression stages is used to drive the chiller. That option is especially relevant when the prime mover is an electric motor (rather than a fueled engine or turbine), where there is no availability of hot exhaust gases or hot jacket water to drive the chiller.

It should be noted that FIG. 4 shows only one possible set of temperature and pressure conditions, and equipment arrangement, with the intention of producing LNG at a specific storage temperature and pressure. Other similar conditions and configurations may be designed to optimize the LNG production process at warmer temperatures and somewhat higher pressures, and in response to site-specific conditions such as (but not limited to) the chemical composition of the feed gas, its feed pressure and temperature, the choice of the prime mover, and the scale of the plant. Thus, FIGS. 5, 6 and 7 refrain from noting specific temperatures and pressures, and (for LNG production) allowing for very much the same pressure and temperature conditions as shown on FIG. 4, but also allowing for higher pressures and slightly warmer conditions, as discussed below, for the production of CCNG.

When the process shown in FIG. 4 is used to produce CCNG, as illustrated by FIG. 6, at least the following adjustments to the process would be made: a) The pressures at points 8, 9, and 13a (or through HX5 on FIG. 6) would be slightly above about 700 psia, allowing for pressure drop through the process and resulting in the delivery of the CCNG to its storage tank at about 700 psia or greater pressure; b) The outflow temperature from the pressure letdown device near point 13a (preferably a multi-phase compressor-loaded expander E2 and C5 on FIGS. 5 and 6) would produce the same about −254° F. two-phase stream, but with a larger liquid portion than would be produced by a JT valve, and/or requiring a smaller flow rate through the device, resulting in a smaller recycle stream; c) the product stream at points 10 to 11 on FIG. 4, and shown exiting HX5S on FIG. 6, would arrive at the storage tank at about −150° F. or colder, at a pressure of about 700 psia or greater. The actual configuration of HX 101, the need (or lack of need) for HX 101S, and the exact temperatures, pressures and flow rates of the natural gas streams though the main heat exchanger array will be determined for each set of product conditions by well known thermodynamic simulations by commonly available software that will insure that the “cooling curves” of the gas streams do not “cross” (do not violate the laws of thermodynamics) and that the cryogenic heat exchanger will perform as intended.

The process shown in FIGS. 4, 5, 6 and 7 can include many of the adjustments outlined above, and can be operated in an LNG production mode, producing various “grades” of LNG from as cold as approximately −250° F. to as warm as approximately −160 F, with a pressure range of approximately 60 psia to about 500 psia; or the process can produce various “grades” of CCNG, from as warm as about −118° F. at about 700 psia to as cold as any LNG product but at pressures above about 700 psia, yielding non-liquid, high-density, cryogenic natural gas. Those various products can be produced during different time slots, or at the same time, depending on product demand. For example, if both LNG and CCNG were desired, only a portion of the feed gas would be compressed to above about 700 psia, with the remaining portion moving through the process at the approximately 400-psia pressure, producing LNG. The about 700-psia portion would receive less refrigeration and would reach its CCNG storage tank sooner than the about 400-psia portion destined for an LNG tank. The lowest operating costs, primarily because of the reduced energy input requirement, will be for CCNG production. The commercial viability of such Small-Scale LNG/CCNG plants may require that the plant operate 24-hours per day and as many as 355 days per year. As such, its capacity (measured, for example, in “gallons” per day) would match the daily or weekly demand by the vehicle fleet served by the plant, with the LNG/CCNG storage tanks acting as a buffer between the hourly/daily production rate and the hourly/daily product demand rate. This paragraph discloses one embodiment of how to make LNG and CCNG at the same time with the same equipment.

FIG. 8 is a phase diagram for methane and is an analog for the phased diagram for natural gas. Although this patent application discusses the invention with respect to natural gas and various compositions of natural gas, one of ordinary skill in the art will understand that the disclosed application applies also to methane, a main component of natural gas. Methane and natural gas are similar but not identical. Typical natural gas contains about 94% methane, 3% heavier hydrocarbons and 3% CO₂ plus nitrogen as well as small quantities of water and sulfur compounds. CO₂, water and sulfur are usually removed prior to chilling the natural gas to prevent freeze-out. The phase diagram, FIG. 8, can apply to natural gas because it is qualitative in nature. Specific values for critical pressure and critical temperatures discussed in this patent application are for pure methane, however, it will be obvious to those of ordinary skill that slightly different values for critical pressure and critical temperature will be used for natural gas, the exact values will be dependant on the composition of the particular natural gas. At the triple point, the natural gas can exist as a solid, vapor and liquid. A solid-vapor coexistence curve 10 extends downwards and leftwards from the triple point. A solid-liquid coexistence curve 14 extends generally upwards from the triple point. A liquid-vapor coexistence curve 18 extends upwards and rightwards from the triple point up to the critical point. It is generally accepted that above the critical temperature (“T_{CRITICAL}”) and above the critical pressure (“P_{CRITICAL}”) for a composition, it exists in a supercritical state. The region above the critical temperature and above the critical pressure shall be referred to the as the supercritical region, and fluids within that region shall be referred to as supercritical fluids. The region to the left of the supercritical region, that is, the region above the critical pressure, and below the critical temperature, and to the right of the solid-liquid coexistence curve shall be referred to as the cold compressed region in this disclosure, and fluids within that region shall be referred to as cold compressed fluids. The cold compressed region is indicated by the hatch marks in FIG. 8. Fluids in the supercritical region have unique properties, including existing as a single-phase fluid. Fluids in the cold compressed region have some of the same characteristics of supercritical fluids, including existing as a single-phase fluid. Additionally, fluids in the cold compressed region have densities approaching that of LNG. It should be noted that fluids in the cold compressed region are not technically in a liquid phase, but are technically in a gas phase.

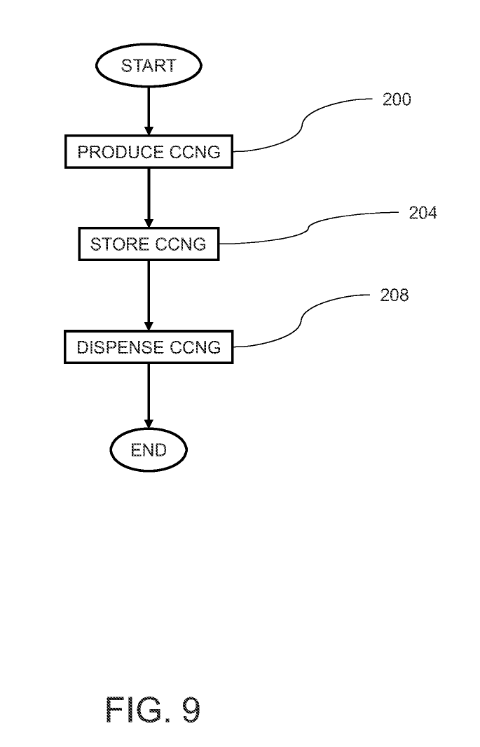

FIG. 9 is a flowchart showing another method of the invention. At act 200 the system produces cold compressed natural gas, as shown in the phase diagram at FIG. 8. At act 204, the system stores the cold compressed natural gas. At act 208 the cold compressed natural gas is dispensed. The natural gas may be dispensed to vehicles to be used as fuel for those vehicles, for instance.

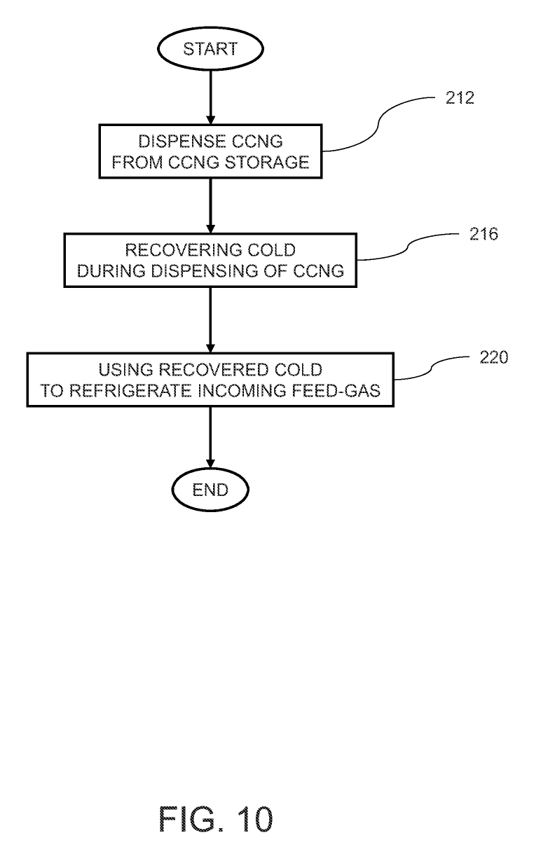

FIG. 10 is a flowchart showing another method of the invention. At act 212, the cold compressed natural gas (CCNG) is dispensed from a cold compressed natural gas (CCNG) storage system, which could be a stationary or mobile tank, or any other suitable storage means. At act 216, the cold is recovered from the cold compressed natural gas (CCNG), during the dispensing of the cold compressed natural gas. At act 220, the recovered cold is used to refrigerate incoming natural gas, or “feed-gas,” (which has been cleaned of is water and CO₂ content in a molecular sieve or other such device, to a level sufficient for cryogenic processing), such that the feed-gas replaces a portion of the outgoing LNG/CCNG, and where the heat content of that feed-gas warms the CNG that is derived from the pumped-to-pressure (formerly) LNG/CCNG. The refrigeration (cooling) of the feed-gas may occur in optimal steps of compression and refrigeration, where the “cold recovery” from the outbound LNG/CCNG reduces the need for newly generated refrigeration input. In effect, by storing LNG/CCNG prior to dispensing it as CNG, refrigeration input is also stored, and can be recovered during the CNG outflow, because that CNG that is dispensed from the LNG/CCNG needs to be much warmer (above about −20° F.) then the stored LNG/CCNG, which is about −150° F. or colder. In this way, the disclosed system manages to produce a storable and pump-able dense-phase natural gas product that can be dispensed as CNG, but which CNG is cooler than standard CNG (and therefore denser), and which CNG can be stored in existing, non-cryogenic, on-vehicle CNG fuel tanks

Returning to FIG. 5, we will now describe the method shown as but one embodiment of the disclosure. The natural gas to be liquefied enters the process at the point which is labeled “NG,” which represents a natural gas pipeline or well, and may also represent other natural gas sources such as landfill gas (LFG) and anaerobic digester gas (ADG), or associated gas from oil wells or any other natural gas source. That “feed gas” needs to be cleaned of any water content and CO₂ in order to avoid ice formation in the cryogenic portions of the process. The symbol for a Molecular Sieve (MS) or “mole sieve” is shown as the device that removes the water and CO₂ from the feed gas. As noted above, other clean up systems can also be used. For “pipeline quality” natural gas, mole sieves will adequately remove the water and CO₂ from the feed gas. For feed gas, such as LFG and ADG that contain other contaminants or large amounts of water and CO₂, a more complex clean up system will be required. Such systems are well understood by those familiar with gas clean up issues.

After clean up, the feed gas moves on to HX2 where it is pre-cooled by a portion of the refrigerant output (shown as stream R) of the Chiller. Also, the feed gas is blended with a recycle stream of natural gas that results from pressure letdown later on the process. That blended stream enters the second stage of compression and its pressure is increased by a ratio that may range from two-to-one to a ratio of four-to-one, depending on the number of compressor stages selected. The heat of compression is dissipated in a Fin-Fan cooler (F2). The now near-ambient gas stream moves on the HX3 where it is cooled to approximately 30° F. by a portion of the refrigeration output of the Chiller. Such pre-cooling before each stage of compression helps reduce the workload of the compressor.

Next, the gas stream is compressed in the third (or last stage) of the compressor to the approximately 400 psia that is needed for LNG production. The heat of compression is dissipated in F3, and final pre-cooling is accomplished in HX4. As discussed above, in the description of FIG. 4, that pre-cooling can achieve temperatures as cold as about −22° F., when the Chiller is an Ammonia Absorption Chiller. The embodiment described in FIG. 5 assumes that the Chiller is based on Lithium Bromide (absorption) technology or on desiccant based adsorption technology, which produce a lower grade of refrigeration but operate with lower-grade heat sources. Thus, the gas stream enters HX5 at approximately 52° F., where it is chilled to cryogenic temperatures by two refrigeration sources, both of which use the same methane that is the product stream as refrigerant streams. A portion of the stream that entered HX5 leaves that brazed aluminum, plate fin, cryogenic heat exchanger as a cold stream (approximately −100° F.) and is expanded in E1 (which is loaded by C4), producing a colder but lower pressure outflow from E1, which is sent back to HX5 as a source of refrigeration. The outflow stream from E1 will be approximately −220° F. The second refrigeration stream is that portion of the original stream that entered HX5, which is sent on to a valve (shown near E2) for further splitting. The valve sends one portion to E2 which, as described above, is a radial expander, loaded by compressor C5, which cause the stream through it to be chilled to approximately −254° F., and which stream is a two phase (liquid and vapor) stream. That liquid plus vapor stream further chills (in HX5S) the part of the stream that was separated by the valve near E2. It is the liquid aspect of the outflow from E2 that delivers the most significant refrigeration to the product stream because that liquid is subject to a phase shift, absorbing heat from the product stream, which vaporizes the liquid portion that left E2.

The product stream, having been liquefied by heat exchange from the outflow from E2 is then allowed to enter the cryogenic storage tank as LNG. As discussed above, the LNG's temperature and pressure can be “designed” for different end uses.

Meanwhile, the refrigerant stream that caused the liquefaction of the product stream in HX5S moves through HX5 to give up any remaining refrigeration to the other streams in HX5, and then exits HX5 at colder than zero F but warmer than about −30° F., and is sent to C5 for some compression. The purpose of C5 is to “load” E2, so that work can be performed and refrigeration produced in E2. The impact of C5 on raising the pressure of that recycle stream will vary, depending on design decisions for each deployment. After compression in C5, that recycle stream enters HX6, where it is cooled by the remaining refrigeration contained in the outflow from E, (which leaves HX5 at colder than zero degrees F.).

The next stop for the cooled and somewhat compressed recycle stream is to be further compressed in C1 of the main compressor. That heat of compression is dissipated in F1, and the recycle stream is further cooled in HX2 by the refrigerant output of the Chiller (shown as stream A′), where the recycle stream is blended with the cleaned process stream.

Meanwhile, the recycle stream that left E1 and HX5, and was also used as a refrigerant in HX6, is compressed in C4, which loads E1. Again, the purpose of C4 is to allow E1 to produce work, thus creating refrigeration. After C4 that second recycle stream's heat of compression is dissipated in F4. The stream is further cooled in HX7 by Chiller-produced stream A-B. The second recycle stream then enter C2 and, along with the clean feed gas and the recycle stream that left C1, is compressed to at least a two-to-one ratio, depending on the total number of compression stages selected by the process designer. The combined streams leave C2 at the selected pressure (approximately 200 psia or higher) and then move on to F2 for the dissipation of the heat of compression. (It should be noted that each trip through a heat exchanger or a Fin-Fan cooler will cause a, say, about one pound pressure drop, which needs to be accounted for in the overall pressure increase ratios at each compressor in the process.) After F2, the combined gas stream is pre-cooled in HX3 by the refrigerant output of the Chiller, and then the gas stream moves on to C3, which on FIG. 5 is the final compression stage.

Exiting C3, the combined gas stream's heat of compression is dissipated in F3. The gas stream is pre-cooled in HX4 and enters HX5 as discussed above. Thus, the gas stream that enters HX5 is a product stream that ends up as LNG after leavening HX5S and is two refrigerant streams (one cooled by E2 and the second one cooled by E1), where the two refrigerant streams are recycled through several steps of “cold recovery” and compression.

Returning to the Chiller on FIG. 5, it is seen that its heat source is hot water that is heated in HX1 by the hot exhaust of the engine (or turbine) and by the hot water that cools the engine. The refrigerant output from the chiller is shown as stream R, which is used to cool the natural gas streams in HX2, HX3, HX4 and HX7. A cooling tower (CT) dissipates waste heat from the Chiller. Thus, FIG. 5, like FIG. 4, illustrates the integration of a waste-heat driven Chiller with the prime mover, so that the waste heat can be converted to useful refrigeration. In FIG. 5, the refrigeration is relatively low grade (as compared to the higher-grade refrigeration illustrated in FIG. 4). That reduction in refrigeration potential is made up by the increased refrigeration output of the E2-C5 array, as a replacement for the JT valve shown on FIG. 4.

In other words, FIG. 5 is a variation on the principles outlined in FIG. 4. However, elements of FIG. 4 can be combined with elements from FIG. 5. For example, if an AAC were used in FIG. 5, along with the E2-05 array (substituting for the JT valve in FIG. 4) the efficiency of process would improve, yielding a higher flow rate of LNG into storage with the same energy input at the prime mover, or the same flow rate of LNG into storage with less energy input at the prime mover.

Thus FIG. 5 is just one new embodiment of the previously disclosed process, and many variations on FIGS. 4 and 5 are foreseen. Indeed, FIG. 6 is one such variation, which will be discussed next.

FIG. 6 is yet another embodiment of the disclosed invention, illustrating the use of an electric motor as the prime mover (in lieu of a fueled engine or turbine). The discussion that follows will assume that the product sent to the storage tank (at the bottom right of the Figure) is CCNG. However, FIG. 6, with its electric motor prime mover and other features can also produce LNG, much like the process discussed in FIGS. 4 and 5. As in the discussion of FIG. 5, pressures, temperatures and flow rates of the various streams shown on FIG. 6 are not specified, because the process sown on FIG. 6 will function under a wider range of pressure, temperatures and flow rates. Instead, the discussion that follows will offer approximate conditions as well as preferable conditions.

As in FIGS. 4 and 5, the process in FIG. 6 begins with the natural gas feed (from any source) at point NG, moving on the mole sieve (or any suitable gas clean up equipment, designed for the specific chemical composition of the feed gas) and through HX2, where it is blended with a recycle stream, cooled by the refrigerant output of the Chiller, and then sent on to C2 for compression, as described above in the discussion of FIG. 5. However, because the prime mover in FIG. 6 is an electric motor, which produces very little in the way of waste heat, the heat source for the Chiller is the heat of compression produced in the several stages of the main natural gas compressor, including (but not limited to) C2, C3 and C4. Other heat sources may include the outflow stream of the Mole Sieve, which is often at temperatures reaching above about 200° F., or any other waste hat source.

Instead of a Fin-Fan cooler at the outflow from C2, C3 and C4, FIG. 6 shows that the heat-bearing gas stream is first sent to HX1 where it heats the hot water that drives the Chiller. The temperature of each of the gas streams shown (C-D, E-F, and G-H) need to be warmer than the return water from the Chiller, (warmer than approximately 140° F.) and at least one of the streams needs to be as warm as approximately 167° F. If the gas streams leaving the several stages of compression are as warm as those temperatures, they will provide enough heat to the Chiller for it to provide the low-grade refrigeration (about 42° F. to about 50° F.) needed for the streams moving through HX2, HX3 and HX4. Preferably, (from the Chiller's point of view), at least one of streams C-D, E-F or G-H will be hotter than about 167° F., and most preferably, as hot as about 203° F., thus yielding a more efficient Chiller output, as measured in the Chiller's Coefficient of Performance, also known as COP. As discussed above, the refrigerant streams are shown as R, cooling the natural gas streams in HX2, HX3 and HX4. Optionally, but not shown on FIG. 6, Fin-Fan coolers may be located near points D, F, and H, after the natural gas streams leave HX1, but before they move on to HX3 for pre-cooling. (As mentioned above, such Fin-Fan cooling can occur in a single, consolidated unit that receives multiple streams for cooling, rather than many individual Fin-Fan units.)

FIG. 6 shows a four-stage compressor (as compared to the three-stage compressors shown in FIGS. 4 and 5.), because the outlet pressure after C4 will be higher than about 700 psia, (approximately 703 psia) in order to allow for pressure drop through HX5 and HX5S, and thus allow the end product (CCNG) to arrive at the storage tank at a pressure of about 700 psia or greater.

After each stage of compression and with the heat of compression given up to warm the hot water that drives the Chiller, the natural gas streams are pre-cooled in HX3 and then sent on to HX5 for further cooling as described above. However, when FIG. 6 describes the production of CCNG, the cooling of the product stream in HX5 and HX5 S need not result in a stream that is colder than about −150° F. (Optionally, any temperature between about −150° F. and about −245° F. can be selected.) Thus, when producing the relatively warm CCNG, the flow rates through E2 and E1 may be reduced by as much as 25% compared to the equivalent points on FIGS. 4 and 5. In other words, the recycle streams that leave E2 and El, and which must be re-compressed in Cl and C2, respectively, will be smaller streams, requiring less “recycle work” by the compressor and allowing more of its work output to be applied to the portion of the gas stream that ends up in the storage tank as CCNG.

Thus, when the process illustrated in FIG. 6 is used to make CCNG the disclosed process satisfies the goals of the invention by producing a dense-phase, non-liquid, cryogenic, pump-able phase of natural gas with lower energy input costs than the production of standard (temperature and pressure) LNG. Also, the process illustrated in FIG. 6 can produce “warm” LNG, a dense-phase, liquid, cryogenic, pump-able phase of natural gas with lower energy input costs than the production of colder LNG typically produced in other LNG plants.

As noted above, the core elements of FIG. 6 can be applied to FIGS. 4 and 5. For example, even if a fueled prime mover is used (an engine or a turbine), FIGS. 4 and 5 can benefit from the recovery of the heat of compression to help warm the hot water used by the Chiller. The extra refrigeration produced in that embodiment would, for example, be used to cool the inlet air to the gas turbine (if that is the prime mover), improving the efficiency of the turbine, and reducing its fuel demand relative to its power output. Similarly, the choice of a four-stage compressor, rather than the three-stage designs shown on FIGS. 4 and 5, can reduce the energy input needed by the compressor, but generate a higher capital cost. In summary, process engineers can adjust the disclosed process to respond to specific feed gas sources and to specific end products sought.

Turning to FIG. 7, the benefits of the disclosure relative to CNG dispensing is illustrated as another embodiment. Like in FIG. 6, the product sent to the storage tank can be any “grade” of LNG (from “warm” to cold) and any grade of CCNG, from as cold as approximately −150° F. to any colder storage temperature. The production of the stored product would, ideally, be designed to be a full time, 24-hours per day process, with enough on-site storage capacity to act as a buffer between the production rate and the dispensing rate of CNG. The total daily (or weekly) production rate will match the total CNG demand and any demand for off-site use of the product, which would be transported to those off-site customers by CCNG tanker truck. (Such CCNG tankers are similar to LNG tankers but with a higher pressure tolerance.)

In most aspects, FIG. 7 is similar to FIG. 6. The CNG dispensing and “cold recovery” aspects of the disclosure constitute the extra information offered on FIG. 7. Starting at the CCNG storage tank, the product is pumped to pressure by “P,” an electric motor-driven cryogenic liquid pump. (The motor is not shown.) That pump P increases the approximately 700 psia of the stored CCNG to the desired pressure of the CNG to be dispensed, which is generally in the range of 3,000 to 3,600 psia.

The high-pressure CCNG warms slightly (approximately 2-degrees F.) above its storage temperature, warming from, say, about −150° F. to about −148° F. That “cold content” is recovered in HX7, where the high-pressure CCNG is heat exchanged with the pre-cooled gas stream that left HX3 at a temperature as cold as about −22° F. and as warm as about 50° F., (depending on the choice of the Chiller and the available waste heat sources) and which has not yet been chilled in HX5. The chilling of that pre-cooled gas stream in HX7 will cause its temperature to fall to within about 10-degrees of the high-pressure CCNG that is flowing counter to it in HX7. Thus, the process gas stream leaves HX7 and enters HX5 at approximately −138° F., requiring significantly less refrigeration input from E2 and E1 to exit HX5S at about −150° F., ready for storage.

At the same time, the high-pressure CCNG is warmed in HX7 by the process stream, leaving HX7 as CNG (at 3,000 to 3,600 psia) with a temperature of about −20° F. to about 60° F., depending on the inlet temperature of the process gas and the relative flow rates of the process gas and the high-pressure CCNG. The cool CNG (about −20° F. to about 60° F.) is substantially cooler than standard CNG at above about 100° F., and therefore denser than standard CNG. Instead of the approximately 10.5 pounds per cubic feet density of standard CNG, such cool CNG, dispensed from CCNG (or “warm” LNG) will have a density of more than about 13 pounds per cubic feet, substantially increasing the capacity of existing on-board CNG fuel tanks

The disclosed process illustrated on FIG. 7 would function in the same way as shown on FIGS. 4, 5, and 6, reducing the refrigeration demand in HX5 only when cold CCNG (or LNG) is sent out of storage for dispensing as CNG. The program logic of the process would adjust the flow rates through E2 and E1 to reflect the refrigeration delivered by the high-pressure CCNG that is destined to become CNG. Thus, FIG. 7 illustrates a way to “store CNG” (as CCNG or LNG) and to store and recover the refrigeration input required to produce the stored CCNG (or LNG), rather than throwing away that refrigeration, as is the case in all L/CNG dispensing sites that do not have on-site liquefaction equipment.

The disclosed process illustrated on FIG. 7 responds to the shortcomings of existing CNG production models by allowing for a storage mode, by recovering the waste heat of compression and any waste heat produced by a fueled prime mover, and by delivering a cooler and denser form of CNG than can be attained by standard CNG production methods.

The disclosed process illustrated on FIG. 7 can also be integrated with existing CNG dispensing facilities, upgrading those facilities and improving their performance as outlined immediately above. Such a retrofit would utilize the existing compressor, the prime mover, and any gas drying apparatus as the core of the upgrade, and utilize the existing CNG dispensing apparatus.

### Energy Input Costs for Dense Phase Natural Gas, Relative to Density Achieved

The main purpose of producing LNG (at any scale), CCNG, or CNG is to increase the density of natural gas, making it heavier per cubic foot of volume, thus increasing the energy content of the natural gas per a given volume (say, per cubic foot). Generally, LNG is the densest form, with CCNG a close second, and CNG the least dense form.

That range of density, from densest (coldest) LNG to the least dense (and warmest) CNG does not necessarily shed light on the energy input required for each condition relative to the density achieved. In other words, most observers would guess that LNG is the most costly product, because it requires “expensive” refrigeration, and that CNG is the least costly product because it “only” requires compression. However, that “conventional wisdom” is not accurate.

The approximate energy input required to make CNG (at 3,600 psia and 90 F, with a density of 10.65 pounds per cubic foot) from one decatherm of natural gas is 333 kWH. The ratio of that energy input to the density achieved is 333÷10.65=31.3.

By contrast, the VX Cycle will produce LNG (at 65 psia and −245 F, with a density of 25.6 pounds per cubic foot), from the same decatherm of natural gas, using approximately 721 kWH of power. That ratio of power to density achieved is 721÷25.6=28.2, which is lower than for CNG. In other words, the VX Cycle will achieve a higher-density product at a lower energy input cost (per density achieved) then standard CNG production systems. Stated differently, VX Cycle LNG will cost less to produce than CNG, when accounting for what is achieved.

More to the point of the CIP, “warm” LNG and CCNG produced by the VX Cycle are the most cost-efficient products, per the following:
LNG (at 500 psia and −158° F., with a density of 20.4 pounds per cubic foot), from the same decatherm of natural gas, will require approximately 513 kWH of power to produce. The ratio of power to density achieved is 531.2÷20.4=25.2.
CCNG (at 700 psia and −150° F., with a density of 19.8 pounds per cubic foot), from the same decatherm of natural gas, will require approximately 500 kWH of power to produce. The ratio of power to density achieved is 500÷19.8=25.3.

The energy input to density ratio of VX Cycle “warm” LNG or CCNG is approximately 19% lower than the energy input to density ratio required for standard CNG production. Over the lifetime of any single facility, especially if the feed-gas is on a pipeline, where “retail” prices are the norm, the extra capital cost of VX, compared to a CNG production system, will be quickly offset by the reduced energy input costs.

### VX Cycle “Sweet Spot”

Generally, the coldest LNG is approximately −260° F. at approximately 50 psia. However, for most small-scale applications, including for use as a vehicle fuel, LNG need not be that cold. (The colder the LNG is the more energy input is required for its production, but not in a linear way but “exponentially” because each degree drop in temperature requires an exponential input of energy.)

Coldest LNG (near −260° F.) is necessary if the LNG is to be shipped across the oceans in LNG tankers, where warmer LNG would boil off quicker. Similarly, regional LNG production facilities that produce large amounts of LNG for distribution to individual customers, delivering the LNG in cryogenic trailers, need to produce cold LNG in order to avoid boil off (or “weathering”) during transport and during on-site storage, prior to dispensing.

Because the VX Cycle is primarily (but not exclusively) designed for small-scale LNG production, at the customer's site, avoiding long-distance transport, it can aim for warmer LNG as a product. In other words, the LNG bus or truck that receives the dispensed LNG does not “care” if it is −260° F. or −240° F., as long as the tank is full. (The LNG is vaporized and sent to the engine as gas, so the engine does not “care” what the temperature of the on-board LNG is.)

The innovations described in FIGS. 4, 5, 6, and 7 aim to produce the warmest possible dense-phase natural gas products with the least energy input possible. The “sweet spot” for VX is a range of dense phase products that are −245° F. and warmer (with pressures of 65 psia and greater), but colder than −118° F. and with a pressure that is at least 700 psia. That temperature range (−118° F. to −245° F.) and that pressure range (65 psia to above 700 psia) will yield densities between 25.6 pounds per cubic foot for the coldest point on that “continuum” to approximately 15 pounds per cubic foot for the warmest point.

That entire range of temperatures, pressures and resultant densities is pump-able by cryogenic liquid pumps, even though the warm end of the range is CCNG, a non-liquid phase of natural gas.

That entire range of storable and pump-able products can be achieved by the VX Cycle at a ratio of energy input (kWH) to density that is lower than 30, with most of the conditions on that continuum achieved by VX at a ratio of less than 26.

Thus the VX Cycle identifies a wide-ranging sweet-spot for dense-phase natural gas production where the density of the VX product is between approximately 19 to 25 pounds per cubic foot, and where that density is achieved by the optimal balance between compression and refrigeration input. FIGS. 4, 5, 6, and 7 illustrate the systems for achieving that optimal balance.

Below are suggested operational values for 3 proposed VX systems:
1) Production by VX of a non-liquid, dense-phase, cryogenic form of natural gas, achieved by the optimal balance of compression and refrigeration, rather than first producing LNG and then pumping it to a supercritical (non-liquid) phase.
2) A VX product temperature range between −118° F. and −245° F., preferably between −150 F and −200° F.; with appropriate pressures for those temperature conditions, between 65 psia to above 700 psia and preferably between 285 psia and above 700 psia; and a density range of between 19 pounds per cubic foot to 25.6 pounds per cubic foot.
3) A VX product range where the ratio of energy input required to convert one decatherm of natural gas to a dense-phase cryogenic product that can be pumped by cryogenic liquid pumps is less than 30 and preferably less than 28, and most preferably less than 26.

The disclosed system has many advantages. Returning to FIGS. 1 and 2, the disclosed system starts with low-pressure pipeline-quality natural gas (or low-pressure stranded gas) and a prime mover 10 (such as, but not limited to an engine), which drives a multi-stage compressor. The waste heat of the prime mover is used to heat regeneration gas that “sweeps” one of several beds (sequentially) in a standard molecular sieve 70, removing CO₂ and water, and sending the regeneration gas back to the prime mover. The bulk of the waste heat provides heat to an ammonia absorption chiller 38 that produces a significant amount of refrigeration without any additional fuel use. The ammonia absorption chiller 38, which is integrated with a standard (water) cooling tower 66, helps remove the heat of compression in each stage of the compressor, and significantly pre-cools the CNG stream prior to its entry into the main heat exchanger 90. The pre-cooled, moderate pressure liquefied/CNG (at about 400 psia) is separated into two streams on two occasions, such that one stream becomes the “product” stream, and the other streams act as refrigerant streams. The refrigeration is provided by first and second expansion valves 98, 102 (via the JT effect), and by a compressor-loaded turbo-expander 110, resulting in cold, low-pressure recycle streams that need to return to the main compressor for compression to about 400 psia. Those recycle stream are used as refrigerants in the main heat exchanger 90 and in the sub-cooling heat exchanger 94, with further cold recovery along the return flow of the recycle streams. The disclosed system yields clean, cold, low-pressure, sub-cooled LNG, suitable for a variety of applications (including as a vehicle fuel). The disclosed system does not need complex cascade cycles that use multiple refrigerants and further does not need a separate refrigeration cycle (such as are needed in N₂ expansion systems, or mixed refrigerant systems). The disclosed system does not need to expand high-pressure gas into a low-pressure pipeline such as in standard “pressure letdown” cycles at “gate stations”. The disclosed system results in a ratio of produced product (LNG) to fuel use that will be better than 80 to 20, and possibly in excess of 85 to 15, depending on further optimizations and the internal efficiencies of the main components.

As outlined in more detail above and below, the disclosed system offers many advantages over standard LNG production and to standard CNG production. Broadly, with regard to LNG production, the disclosed system may produce a wide-range of LNG products (as measured by the temperature, pressure and density of the LNG), but with lower refrigeration input costs, which yield lower fuel and operating costs, using readily available equipment. As in the parent application the disclosed system can operate with low-pressure feed gas, with only two natural gas expansion devices, and at production scales as small as 6,000 liters per day. In summary, the disclosed system may produce storable, pump-able, and transportable LNG from low-pressure feed gas sources, at small production scales and at lower energy input costs than other systems facing the same low-pressure and small-scale challenges.

With regard to CCNG production, the disclosed system offers many advantages over standard LNG production and to standard CNG production. The disclosed system may produce a new range of dense-phase natural gas products (CCNG) that, while not a liquid, can be stored and transported in moderate-pressure cryogenic storage containers, and, most importantly, can be pumped by cryogenic liquid pumps to any desired pressure. That range of dense-phase natural gas products (CCNG of varying temperatures colder than about −150° F., and varying pressures higher than about 700 psia), may be produced with lower refrigeration input costs, yielding lower fuel and operating costs, using readily available equipment. As in the parent application, the disclosed system can operate with low-pressure feed gas, with only two natural gas expansion devices, and at production scales as small as 6,000 liters per day. In summary, the disclosed system may produce storable, pump-able, and transportable CCNG from low-pressure feed gas sources, at small production scales and at lower energy input costs than other systems facing the same low-pressure and small-scale challenges.

With regard to CNG production, the disclosed system offers a cost-effective way to produce dense-phase natural gas (CCNG) during off-peak periods, which can be pumped by cryogenic liquid pumps to any desired pressure, for dispensing as cooler-than-standard (and denser) CNG, suitable for use in existing on-vehicle CNG fuel tanks, using readily available components, only two expansion devices, at scales as small as the equivalent of 6,000 liquid gallons per day. In summary, the disclosed system may produce a storable and pump-able dense-phase natural gas that can be dispensed as CNG, but without losing the refrigeration content inherent in the stored CCNG (as compared to standard L/CNG systems where the refrigeration content is lost), and which can be sited at a low-pressure feed gas source, at production scales suitable for individual CNG fleets, and which system will have a lower energy input cost than any L/CNG dispensing system, rivaling the energy input costs of standard CNG production/dispensing systems, but yielding colder/denser CNG.

It should be noted that all temperatures and pressures listed are approximate, and the disclosed system will work at other selected temperature and pressure values, but the about 400 psia range of the CNG is a “sweet spot” for a methane expansion cycle. The heat recovery from the prime mover 10, and the use of the ammonia absorption chiller 38 is not an essential element of the innovation. For example, a high-efficiency gas-fired turbine (for example, with an adjacent steam cycle or an organic Rankine cycle) may increase the efficiency of the prime mover 10 (by using its waste heat) such that the operation of the ammonia absorption chiller 38 would not be viable. In that event, the disclosed system would “spend” more energy on compressing the CNG, but by way of a more efficient prime mover, thus causing the total energy use to be about the same. Similarly, the main compressor 34 may be, in an alternative embodiment of the disclosed system, an electric power driven compressor, especially where low-cost electricity is available. The vapor return stream shown on the process flow diagram is to allow any “flash” from the liquefied natural gas-fueled vehicle's storage tank to be recycled, rather than vented. The vapor return stream may travel within a vapor return line 125. The process flow diagram shown in FIGS. 1 and 2 is for an about 6,000-liter/day plant with a low-pressure pipeline, for such customers as LNG vehicles. However, the disclosed system is not limited to small-scale (pipeline based) plants. It is unique in its efficiency and relative simplicity and therefore suitable for small-scale, low-pressure pipeline sites. However, it will work as well (and more efficiently) on higher-pressure gas sources (pipelines, and wells) and at larger scales. The make up water line 122 on FIG. 1 would come from a standard “city water line”. The 4-way valve 126 shown on FIG. 2 is merely a “diagram”. In reality, those valves will not be in a single location, as shown. Some streams may enter other streams through “T” connections without valves. Thus the 4-way valve may comprise a single 4-way valve, or a plurality of valves. The flow-rates of the various streams are not discussed above because that will vary for each plant, based on its size. For the about 6,000-liter/day plant discussed here, the following are approximate gas flow rates (in pounds per hour) at typical points in the cycle. The flow rate of LNG (not including the heavies), at point 12 in the process flow diagram is approximately 207 lb/h; the make-up stream from the pipeline will contain about 327 lb/h, of which approximately 60 lb/h are used as fuel by the prime mover; the flow rate at point 9 will be approximately 386 lb/h; the flash recycle stream at point 15 will be approximately 179 lb/h; the stream traveling to the expander toward point 16 will be approximately 1,450 lb/h; the recycle stream at point 17a, having given up its heavies content through point 16h, will pass through 17a at approximately 1,398 lb/h; while the recycle stream from the sub-cooler, through point 18 and 18a is 179 lb/h. Those flow rates can vary depending on factors such as the energy content of the feed gas; the amount of heavy hydrocarbons in the feed; the efficiency of the various components, especially the prime mover and the cryogenic expander; the desired temperature and pressure of the stored LNG; and the level of insulation of all the pipes and cryogenic components. Of course the above listed values can be adjusted, modified and tuned by system engineers, dependent on various factors, such as but not limited to desired output. The liquid heavies separator 130 (and the stream of liquid heavy hydrocarbons) may be in the plant, but may not need to function on those days when the make up stream is very low in heavies. However, if the stream is more laden with heavies, then some of those heavies could be sent to the engine for fuel, rather than to the LNG tank. The above description does not dwell on the type of heat exchangers used, because those choices are well understood by gas process engineers and are not relevant to the core innovations of the disclosed system. The disclosed system's relatively modest operating pressures will result in cost savings on all components, including heat exchangers, when compared to other cycles that operate at higher pressures. A discussion of the appropriate insulation of hot and cold lines, and the design of valves and sensors are not covered above because those technologies are well understood by process engineers.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

1. A system for the small-scale production of liquid natural gas comprising:
a natural gas supply, the natural gas supply being at a pressure in a range of about 55 psia to about 350 psia;
a prime mover in fluid communication with the natural gas supply, and in fluid communication with a third heat exchanger;
a multi-stage compressor in operational communication with the prime mover; the multi-stage compressor comprising at least a first stage compressor, a second stage compressor, and a third stage compressor, and where the inlet temperature of fluid entering the first stage compressor is less than about 40° F., and where the inlet temperature of fluid entering the second stage compressor is less than about 40° F.;
a first inter-cooler in fluid communication with the first stage compressor;
a molecular sieve in fluid communication with the first inter-cooler and in fluid communication with the natural gas supply;
a fourth heat exchanger in fluid communication with the molecular sieve and in fluid communication with the first stage compressor;
a second inter-cooler in fluid communication with the second stage compressor;
a first heat exchanger in fluid communication with the second inter-cooler and in fluid communication with the third stage compressor;
an after-cooler in fluid communication with the third stage compressor;
a second heat exchanger in fluid communication with the after-cooler;
a main heat exchanger in fluid communication with the second heat exchanger, in fluid communication with a phase separator, in fluid communication with a gas turbo-expander, and in fluid communication with the fourth heat exchanger, where the operational flow rate from the main heat exchanger to the gas turbo-expander can be as low as about 1,450 lb/hr during continuous operation;
a first expansion device in fluid communication with the main heat exchanger;
a sub-cooling heat exchanger in fluid communication with the first expansion valve;
a second expansion device in fluid communication with the sub-cooling heat exchanger;
a pressure tank in fluid communication with the second expansion valve;
a four-way valve in fluid communication with the pressure tank;
the four-way valve in fluid communication with the sub-cooling heat exchanger and in fluid communication with the main heat exchanger;
the gas turbo-expander in fluid communication with the phase separator, and in operational communication with an expander driven compressor;
the expander driven compressor in fluid communication with a fifth heat exchanger;
the fifth heat exchanger in fluid communication with second stage compressor;
an ammonia absorption chiller in fluid communication with the prime mover, in fluid communication with the first heat exchanger, in fluid communication with the second heat exchanger, in fluid communication with the third heat exchanger, and in fluid communication with a cooling tower;
a make-up water line in fluid communication with the cooling tower; and
wherein the amount of liquid natural gas produced by this system while continuously running during a 24 hour day can be as low as about 6,000 liters per day, wherein the system has no more than two expansion valves; and wherein the first and second devices are selected from a group consisting of a compressor-loaded multi-phase expander turbine, and an expansion valve.

2. The system of claim 1, further comprising:
a natural gas supply pressure of less than about 55 psia; and
a booster compressor in fluid communication with the natural gas supply and the main natural gas compressor.

3. The system of claim 1, wherein the production, storage and transport of liquid natural gas are at temperatures as warm as about −148° F., and at pressures as high as about 600 psia.

4. The system of claim 1, further comprising:
the production of a range of liquid natural gas with a temperature range of between about −148° F. and −245° F., and preferably between about −150° F. and about −200° F.,
with storage pressures appropriate for all the temperatures within those ranges that are generally between about 65 psia to above about 700 psia, and preferably between about 285 psia to above about 700 psia; and
with a range of densities of the liquid natural gas between about 25.6 pounds per cubic foot to about 19 pounds per cubic foot.

5. The system of claim 1, further comprising a liquid natural gas production mode:
where the multi-stage compressor in fluid communication with the prime mover is used to compress natural gas to pressures about and above about 400 psia;
where the expansion devices and the cryogenic heat exchangers are configured to cool the compressed natural gas to colder than about −160° F.;
which is sent for storage to a cryogenic storage vessel that is suitable for the containment of liquid natural gas, from which it can be dispensed as liquid natural gas;
from which it can be pumped to pressures suitable for cold compressed natural gas and compressed natural gas dispensing by a cryogenic liquid pump,
wherein the system of claim 1 allows for the output of either liquid natural gas, cold compressed natural gas and compressed natural gas, or any combination of those dense-phase natural gas products.

6. The system of claim 1, wherein the first expansion device is a compressor-loaded multi-phase expansion turbine.

7. A system for the small-scale production of cold compressed natural gas comprising:
a natural gas supply, the natural gas having a pressure in a range of about 55 psia to about 350 psia;
a prime mover in fluid communication with the natural gas supply, and in fluid communication with a third heat exchanger;
a multi-stage compressor in operational communication with the prime mover; the multi-stage compressor comprising a first stage compressor, a second stage compressor, and a third stage compressor, and where the inlet temperature of fluid entering the first stage compressor is less than about 40° F., and where the inlet temperature of fluid entering subsequent stages of the compressor is less than 40° F.;
a first inter-cooler in fluid communication with the first stage compressor and with a waste heat driven chiller;
a molecular sieve in fluid communication with the first inter-cooler and in fluid communication with the natural gas supply;
a fourth heat exchanger in fluid communication with the molecular sieve and in fluid communication with the first stage compressor;
a second inter-cooler in fluid communication with a waste heat driven chiller and the second stage compressor;
a first heat exchanger in fluid communication with the second inter-cooler, a waste heat driven chiller and in fluid communication with the third stage compressor;
an after-cooler in fluid communication with the third stage compressor and with a waste heat driven chiller;
a second heat exchanger in fluid communication with the after-cooler and with a waste heat driven chiller;
a main heat exchanger in fluid communication with the second heat exchanger, in fluid communication with a phase separator, in fluid communication with a compressor-loaded gas turbo-expander, and in fluid communication with the fourth heat exchanger, where the operational flow rate from the main heat exchanger to the gas turbo-expander can be as low as about 1450 lb/hr during continuous operation;
a first expansion device, such as a throttle valve or compressor-loaded multi-phase expander, in fluid communication with the main heat exchanger;
a sub-cooling heat exchanger in fluid communication with the first expansion valve or compressor-loaded multi-phase expander;
a pressure tank in fluid communication with the second expansion valve;
a four-way valve in fluid communication with the pressure tank;
the four-way valve in fluid communication with the sub-cooling heat exchanger and in fluid communication with the main heat exchanger;
the gas turbo-expander in fluid communication with the phase separator, and in operational communication with an expander driven compressor;
the expander driven compressor in fluid communication with a fifth heat exchanger;
the fifth heat exchanger in fluid communication with one of the stages of a multi-stage natural gas compressor;
an ammonia or lithium bromide absorption chiller or an adsorption chiller in fluid communication with the prime mover, in fluid communication with the first heat exchanger, in fluid communication with the second heat exchanger, in fluid communication with the third heat exchanger, and in fluid communication with a cooling tower; a make-up water line in fluid communication with the cooling tower; and
wherein the amount of cold compressed natural gas produced by this system while continuously running during a 24 hour day can be as low as the liquid equivalent of about 6,000 liters per day, and wherein the system has no more than two natural gas expansion devices.

8. The system of claim 7, wherein the pressure tank is configured to hold a single-phase non-liquid state of natural gas at a temperature above its critical temperature and at a pressure above its critical pressure and wherein the critical pressure of the single-phase non-liquid state natural gas is about −150° F. or colder, and the critical pressure of the single-phase non-liquid state natural gas is about 700 psia or greater.

9. The system of claim 7, wherein the pressure of the fluid leaving the final stage of the multi-stage compressor is about 705 psia.

10. The system of claim 7, further comprising:
The production, storage and transport of cold compressed natural gas at temperatures as warm as −118° F.; and
at pressures higher than about 700 psia.

11. The system of claim 7, further comprising:
a natural gas supply pressure of less than about 60 psia; and
a booster compressor in fluid communication with the natural gas supply and the main natural gas compressor.

12. The system of claim 7, further comprising:
a cryogenic liquid pump in fluid communication with the cryogenic product storage tank, and configured to pump the non-liquid cold compressed natural gas up to the high-pressures required for compressed natural gas dispensing.

13. The system of claim 12, wherein the cryogenic liquid pump is configured to pump the cold compressed natural gas to a pressure of about 3,000 psia to about 3,600 psia.

14. The system of claim 7, further comprising a cold compressed natural gas production mode:
where the multi-stage compressor in fluid communication with the prime mover is used to compress natural gas to pressures about and above 700 psia;
where the expansion devices and the cryogenic heat exchangers are configured to cool the compressed natural gas to about −150° F.;
where that chilled natural gas is sent for storage to a cryogenic storage vessel suitable for the containment of cold compressed natural gas;
from which it can be dispensed as cold compressed natural gas, and from which it can be pumped to a pressure by a cryogenic liquid pump; and
wherein after pumping, that pressure is suitable for compressed natural gas dispensing.

15. A method of dispensing natural gas from stored cold compressed natural gas, the method comprising:
dispensing cold compressed natural gas from a cold compressed natural gas storage tank, with or without pumping it with a cryogenic liquid pump to a higher pressure;
pumping the cold compressed natural gas by a cryogenic liquid pump to a pressure suitable for compressed natural gas dispensing and storage in on-vehicle compressed natural gas storage tanks;
recovering cold from the cold compressed natural gas by heat exchange with natural gas feeding the natural gas production plant to replace dispensed product, such that the incoming, relatively warm, feed-gas warms the pumped-to-pressure cold compressed natural gas to a temperature of about −20° F. to about 30° F., thus converting it from cold compressed natural gas to compressed natural gas;
where the refrigeration content of the outbound cold compressed natural gas is used to reduce the refrigeration needed to convert the incoming feed gas to more cold compressed natural gas or liquid natural gas;
where the now warmed gas stream (formerly cold compressed natural gas) is cooler than standard compressed natural gas but can be stored in standard, non-cryogenic, on-board vehicle fuel storage tanks;
thus allowing for a compressed natural gas dispensing facility that can achieve storability and off-peak production, and
yielding a cooler than normal, and thus denser dispensed compressed natural gas,
allowing for existing, standard on-vehicle compressed natural gas tanks to take away more product (as measured in pounds per cubic foot of fuel tank capacity), then is achievable with standard compressed natural gas at the same pressure but as warm as about 100° F.

16. The method of claim 15 wherein the storage tank is configured to hold a natural gas selected from the group consisting of a liquid phase of natural gas; a single-phase non-liquid state of natural gas at a temperature above its critical temperature of about −150° F. and at pressure above its critical pressure of about 700 psia; and a mixed phase (liquid and non-liquid phase) of natural gas.

17. The method of claim 15 for dispensing natural gas from stored cold compressed natural gas, the method further comprising:
pumping cold compressed natural gas to a high pressure by a cryogenic liquid pump;
recovering cold from the cold compressed natural gas by heat exchanging it with warmer feed-gas, such that the cold compressed natural gas changes to a state of compressed natural gas;
using the recovered cold to produce additional cold compressed natural gas that replaces a portion of cold compressed natural gas-to-compressed natural gas that is dispensed; and
using the warmth of the feed gas to warm the pumped-to-pressure cold compressed natural gas to non-cryogenic temperatures, but which are colder than standard compressed natural gas temperatures.

18. (canceled)
